(19) United States
(12) Patent Application Publication
(10) Pub. No.: US 2018/0346844 A1
(43) Pub. Date: Dec. 6, 2018

(54) FRAGRANCE COMPOSITIONS COMPRISING COMPOUNDS WITH OLFACTORY QUALITIES

(71) Applicant: P2 Science, Inc., Woodbridge, CT (US)

(72) Inventors: Patrick FOLEY, New Haven, CT (US); Yonghua YANG, New Haven, CT (US)

(21) Appl. No.: 16/101,030

(22) Filed: Aug. 10, 2018

Related U.S. Application Data
(63) Continuation of application No. PCT/US2017/017463, filed on Feb. 10, 2017.
(60) Provisional application No. 62/293,686, filed on Feb. 10, 2016.

(51) Int. Cl. C11B 9/00

(52) U.S. Cl. CPC C11B 9/0015

(57) ABSTRACT

The application relates to compositions comprising compounds of Formula I, Formula II, or Formula III and the use of these compositions in the fragrance industry, i.e., for the production of perfumes, air fresheners, laundry detergents, household cleaning products, liquid or bar soaps, shampoos, conditioners, hair sprays, cosmetics, deodorants, insect repellants, insecticides, and pet litter.

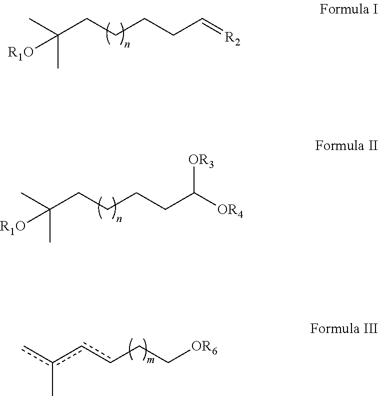

### RELATED APPLICATION

This application claims priority to, and the benefit of, U.S. Provisional Application No. 62/293,686, filed Feb. 10, 2016, the entire contents of which are incorporated herein by reference.

### FIELD OF THE APPLICATION

The present application relates to the use of compounds of Formula I, Formula II, and Formula III in various compositions, including fragrance compositions.

### BACKGROUND

Scent is an important factor used to produce a sense of anticipation, quality, palatability, and security to many consumer products. Identifying effective aromas to impart in a product is an element that contributes to the success of the product, and is useful in product marketing, consumer satisfaction, and consumer retention. Sweet, resinous smells are particularly desirable fragrances and are often used in toiletries, cosmetics, household cleaners, room sprays, laundry, and fine fragrance applications, such as in perfumes and toilet waters.

There is a strong need in the fragrance industry to identify “lily of the valley” or muguet-type compounds to replace or offset the use of Lilial™, which is known to be toxic. Indeed, work focused on discovering such replacements has been published in recent years, including International Publication Nos. WO 2014/180945 A1, WO 2013/045301 A1, and WO 2010/105873 A2.

### SUMMARY

9-hydroxy-9-methyldecanal,

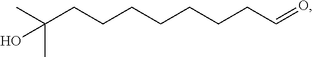

has an enduring “lily of the valley” or muguet-type odor. It has strong tenacity and a pleasant soft, sweet floral character that is very desirable in, for example, fine fragrances, in cleaning compositions, and in air care.

The disclosed 9-hydroxy-9-methyldecanal, and related compounds, e.g., compounds of Formula I, Formula II, and Formula III, may be used to produce fragrance compositions that could replace or offset Lilial™. 9-hydroxy-9-methyldecanal, and other compounds of Formula I, Formula II, and Formula III, could further be used to offset or replace the use of other Lily of the Valley type compounds, such as hydroxycitronellal, Lyral™, Mayol™, or Lilyflore™.

In one aspect, the application relates to a fragrance composition comprising a compound of Formula I.

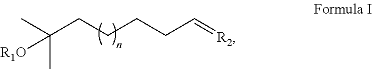

### Formula II,

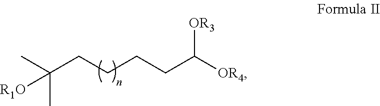

or

### Formula III,

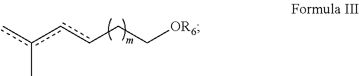 [0010] wherein:
R₁ is H, C₁₋₆ alkyl, or —C(O)C₁₋₆ alkyl;
R₂ is O, CH₂, or CHC₁₋₆ alkyl;
R₃ and R₄ are each C₁₋₆ alkyl;
R₆ is H, C₁₋₆ alkyl, or —C(O)C₁₋₆ alkyl;
n is an integer from 0 to 6; and
m is and integer from 1 to 6;
   wherein at least one of the [symbol] is a double bond, and the remaining [symbol] are single bonds, provided that two adjacent [symbol] are not both double bonds.

In one aspect, the application relates to a fragrance composition comprising a compound of Formula I,

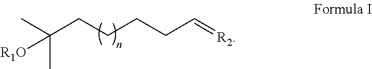

In one embodiment, for any fragrance composition comprising a compound of Formula I, R₁ is H, CH₃, or CH₂CH₃. In one embodiment, for any fragrance composition comprising a compound of Formula I, R₁ is —C(O)CH₃.

In one embodiment, for any fragrance composition comprising a compound of Formula I, R₂ is CH₂ or CHCH₃. In one embodiment, for any fragrance composition comprising a compound of Formula I, R₂ is O.

In one embodiment, for any fragrance composition comprising a compound of Formula I, the compound of Formula I imparts a fragrance to the fragrance composition.

In one aspect, the application relates to a fragrance composition comprising a compound of Formula II,

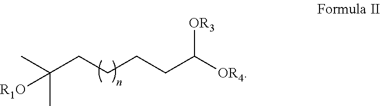

In one embodiment, for any fragrance composition comprising a compound of Formula II, R₃ and R₄ are methyl.

In one embodiment, for any fragrance composition comprising a compound of Formula II, n is 4.

In one embodiment, for any fragrance composition comprising a compound of Formula II, the compound of Formula II imparts a fragrance to the fragrance composition.

In one aspect, the application relates to a fragrance composition comprising a compound of Formula III,

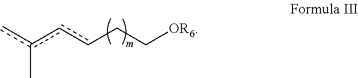

In one embodiment, for any fragrance composition comprising a compound of Formula III, m is 5.

In one embodiment, for any fragrance composition comprising a compound of Formula III, the compound of Formula III imparts a fragrance to the fragrance composition.

In one aspect, the application relates to a fragrance composition comprising a compound selected from:

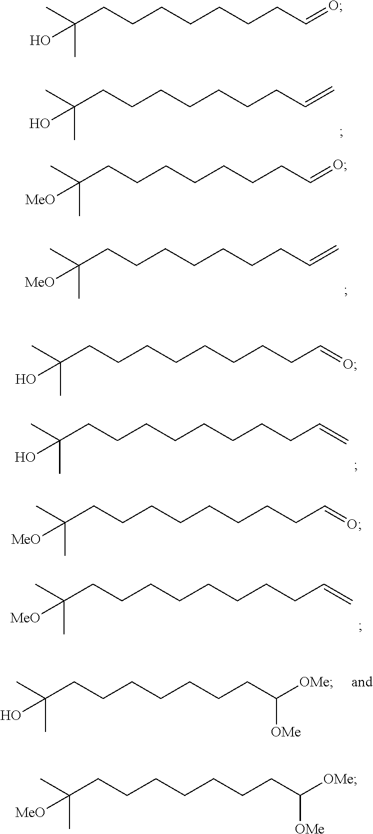

wherein the compound imparts a fragrance to the fragrance composition.

In one aspect, the application relates to a fragrance composition comprising 9-hydroxy-9-methyldecanal,

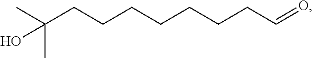

wherein the 9-hydroxy-9-methyldecanal imparts a fragrance to the fragrance composition.

In one aspect, the application relates to a fragrance composition comprising a compound of Formula I, Formula II, or Formula III, wherein the concentration of the compound of Formula I, Formula II, or Formula III is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound of Formula I, wherein the concentration of the compound of Formula I is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound of Formula II, wherein the concentration of the compound of Formula II is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound of Formula III, wherein the concentration of the compound of Formula III is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound selected from:

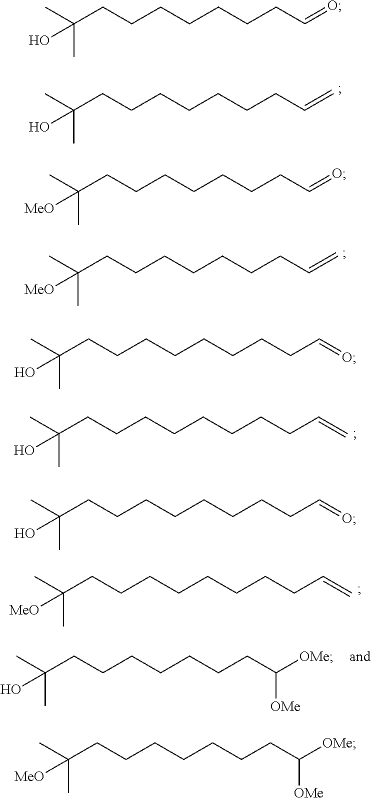

wherein the concentration of the compound is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising 9-hydroxy-9-methyldecanal,

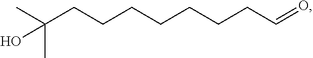

wherein the concentration of 9-hydroxy-9-methyldecanal is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound of Formula I, Formula II, or Formula III, wherein the composition further comprises one or more additives, one or more fragrance ingredients, or a combination thereof.

In one embodiment, the fragrance composition comprising a compound of Formula I, Formula II, or Formula III, comprises at least one additive. In one embodiment, the additive comprises a surfactant.

In one embodiment, the fragrance composition comprising a compound of Formula I, Formula II, or Formula III, comprises at least one fragrance ingredient. In one embodiment, the fragrance ingredient comprises an oil.

In one embodiment, the fragrance composition comprising a compound of Formula I, Formula II, or Formula III, comprises at least one additive and at least one fragrance ingredient.

In one embodiment, the fragrance composition comprising a compound of Formula I, Formula II, or Formula III is for use in a perfume, air freshener, laundry detergent, household cleaning product, liquid or bar soap, shampoo, conditioner, hair spray, cosmetic, makeup, deodorant, insect repellant, insecticide, or pet litter.

In one embodiment, the fragrance composition comprising a compound of Formula I, Formula II, or Formula III is for use in a perfume, parfum, extrait, Esprit de Parfum, Parfum de Toilette, Eau de Toilette, or Eau de Cologne.

In one embodiment, the fragrance composition comprising a compound of Formula I, Formula II, or Formula III is for use in an air freshener, e.g., a spray, candle, oil, bead, wax melt, plug-in, fabric refresher, or car air freshener.

In one embodiment, the fragrance composition comprising a compound of Formula I, Formula II, or Formula III is for use in a household or industrial cleaning product. In one embodiment, the household cleaner is bleach, a shower/bath cleaning product, a toilet-cleaning product, a glass-cleaning product, a tile-cleaning product, a wood-cleaning product, a carpet-cleaning product, or a granite-cleaning product. In one embodiment, the industrial cleaner is an all-purpose cleaner, a high-performance cleaner, or a degreaser.

In one embodiment, the fragrance composition comprising a compound of Formula I, Formula II, or Formula III is for use in a cosmetic, make up, or make up product.

In one embodiment, the fragrance composition comprising a compound of Formula I, Formula II, or Formula III is for use in health and personal care products, e.g., after shave, deodorant, medical spray (athlete's foot), sunscreen, sunburn treatment, wrinkle cream, exfoliator, scrub, moisturizer, lotion, powder, hand soap, hand sanitizer, bar soap, liquid soap, body wash, shampoo, conditioner, baby shampoo, baby oil, acne bar soap, acne cream, or acne gel.

In one embodiment, the fragrance composition comprising a compound of Formula I, Formula II, or Formula III is for use in pet litter.

In one aspect, the application relates to a fragrance composition comprising 9-hydroxy-9-methyldecanal, wherein the composition further comprises one or more additives, one or more fragrance ingredients, or a combination thereof.

In one embodiment, the fragrance composition comprising 9-hydroxy-9-methyldecanal, comprises at least one additive. In one embodiment, the additive comprises a surfactant.

In one embodiment, the fragrance composition comprising 9-hydroxy-9-methyldecanal, comprises at least one fragrance ingredient. In one embodiment, the fragrance ingredient comprises an oil.

In one embodiment, the fragrance composition comprising 9-hydroxy-9-methyldecanal, comprises at least one additive and at least one fragrance ingredient.

In one embodiment, the fragrance composition comprising 9-hydroxy-9-methyldecanal is for use in a perfume, air freshener, laundry detergent, household cleaning product, liquid or bar soap, shampoo, conditioner, hair spray, cosmetic, makeup, deodorant, insect repellant, insecticide, or pet litter.

In one embodiment, the fragrance composition comprising 9-hydroxy-9-methyldecanal is for use in a perfume, parfum, extrait, Esprit de Parfum, Parfum de Toilette, Eau de Toilette, or Eau de Cologne.

In one embodiment, the fragrance composition comprising 9-hydroxy-9-methyldecanal is for use in an air freshener, e.g., a spray, candle, oil, bead, wax melt, plug-in, fabric refresher, or car air freshener.

In one embodiment, the fragrance composition comprising 9-hydroxy-9-methyldecanal is for use in a household or industrial cleaning product. In one embodiment, the household cleaner is bleach, a shower/bath-cleaning product, a toilet-cleaning product, a glass-cleaning product, a tile-cleaning product, a wood-cleaning product, a carpet-cleaning product, or a granite-cleaning product. In one embodiment, the industrial cleaner is an all-purpose cleaner, a high-performance cleaner, or a degreaser.

In one embodiment, the fragrance composition comprising 9-hydroxy-9-methyldecanal is for use in health and personal care products, e.g., after shave, deodorant, medical spray (athlete's foot), sunscreen, sunburn treatment, wrinkle cream, exfoliator, scrub, moisturizer, lotion, powder, hand soap, hand sanitizer, bar soap, liquid soap, body wash, shampoo, conditioner, baby shampoo, baby oil, acne bar soap, acne cream, or acne gel.

In one embodiment, the fragrance composition comprising 9-hydroxy-9-methyldecanal is for use in a cosmetic, make up, or make up product.

In one embodiment, the fragrance composition comprising 9-hydroxy-9-methyldecanal is for use in pet litter.

Unless otherwise defined, all technical and scientific terms used herein have the same meaning as commonly understood by one of ordinary skill in the art to which this application belongs. In the specification, the singular forms also include the plural unless the context clearly dictates otherwise. Although methods and materials similar or equivalent to those described herein can be used in the practice or testing of the present application, suitable methods and materials are described below. In addition, the materials, methods, and examples are illustrative only and are not intended to be limiting.

Other features and advantages of the application will be apparent from the following detailed description and claims.

### DETAILED DESCRIPTION

In one aspect, the application relates to a fragrance composition comprising a compound of Formula I,

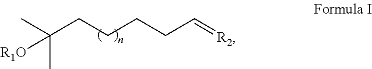

### Formula II,

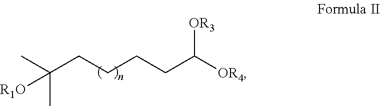

### or Formula III,

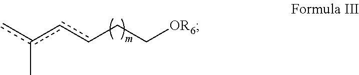 [0064] wherein:
R₁ is H, C₁₋₆ alkyl, or —C(O)C₁₋₆ alkyl;
R₂ is O, CH₂, or CHC₁₋₆ alkyl;
R₃ and R₄ are each C₁₋₆ alkyl;
R₆ is H, C₁₋₆ alkyl, or —C(O)C₁₋₆ alkyl;
n is an integer from 0 to 6; and
m is and integer from 1 to 6;
   wherein at least one of the [symbol] is a double bond, and the remaining [symbol] are single bonds, provided that two adjacent [symbol] are not both double bonds.

In one aspect, the application relates to a fragrance composition comprising a pharmaceutically acceptable salt, hydrate, or solvate of a compound of Formula I, Formula II, or Formula III.

In one aspect, the application relates to a fragrance composition comprising a compound of Formula I,

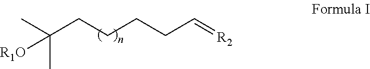

wherein:
R₁ is H, C₁₋₆ alkyl, or —C(O)C₁₋₆ alkyl;
R₂ is O, CH₂, or CHC₁₋₆ alkyl; and
n is an integer from 0 to 6.

In one embodiment, for any fragrance composition comprising a compound of Formula I, R₁ is H, CH₃, or CH₂CH₃. In one embodiment, R₁ is H. In one embodiment, R₁ is CH₃. In one embodiment, R₁ is CH₂CH₃.

In one embodiment, for any fragrance composition comprising a compound of Formula I, R₁ is iso-propyl, n-propyl, iso-butyl, sec-butyl, n-butyl, iso-pentyl, neo-pentyl, n-pentyl, tert-pentyl, sec-pentyl, 3-pentyl, n-hexyl, 2-methyl-pentyl, 3-methyl-pentyl, 2,3-dimethyl-butyl, or 2,2-dimethylbutyl.

In one embodiment, for any fragrance composition comprising a compound of Formula I, R₁ is —C(O)CH₃. In one embodiment, R₁ is —C(O)CH₂CH₃, —C(O)-n-propyl, —C(O)-iso-propyl, —C(O)-iso-butyl, —C(O)-sec-butyl, or —C(O)-n-butyl.

In one embodiment, for any fragrance composition comprising a compound of Formula I, R₂ is CH₂ or CHCH₃. In one embodiment, for any fragrance composition comprising a compound of Formula I, R₂ is O. In one embodiment, for any fragrance composition comprising a compound of Formula I, R₂ is CHCH₂CH₃ or CHCH₂CH₂CH₃

In one embodiment, for any fragrance composition comprising a compound of Formula I, n is an integer from 1 to 6, from 2 to 6, from 3 to 6, from 4 to 6, from 5 to 6, from 0 to 5, from 1 to 5, from 2 to 5, from 3 to 5, from 4 to 5, from 0 to 4, from 1 to 4, from 2 to 4, from 3 to 4, from 0 to 3, from 1 to 3, from 2 to 3, from 0 to 2, from 1 to 2, from 0 to 1.

In one embodiment, for any fragrance composition comprising a compound of Formula I, n is 0, n is 1, n is 2, n is 3, n is 4, n is 5, or n is 6.

In one embodiment, for any fragrance composition comprising a compound of Formula I, R₁ is H and R₂ is CH₂.

In one embodiment, for any fragrance composition comprising a compound of Formula I, R₁ is H and R₂ is CHCH₃.

In one embodiment, for any fragrance composition comprising a compound of Formula I, R₁ is H and R₂ is O.

In one embodiment, for any fragrance composition comprising a compound of Formula I, R₁ is CH₃ and R₂ is CH₂.

In one embodiment, for any fragrance composition comprising a compound of Formula I, R₁ is CH₃ and R₂ is CHCH₃.

In one embodiment, for any fragrance composition comprising a compound of Formula I, R₁ is CH₃ and R₂ is O.

In one embodiment, for any fragrance composition comprising a compound of Formula I, R₁ is CH₂CH₃ and R₂ is CH₂.

In one embodiment, for any fragrance composition comprising a compound of Formula I, R₁ is CH₂CH₃ and R₂ is CHCH₃.

In one embodiment, for any fragrance composition comprising a compound of Formula I, R₁ is CH₂CH₃ and R₂ is O.

In one embodiment, for any fragrance composition comprising a compound of Formula I, R₁ is H; R₂ is CH₂; and n is 0.

In one embodiment, for any fragrance composition comprising a compound of Formula I, R₁ is H; R₂ is CHCH₃; and n is 0.

In one embodiment, for any fragrance composition comprising a compound of Formula I, R₁ is H; R₂ is O; and n is 0.

In one embodiment, for any fragrance composition comprising a compound of Formula I, R₁ is CH₃; R₂ is CH₂; and n is 0.

In one embodiment, for any fragrance composition comprising a compound of Formula I, R₁ is CH₃; R₂ is CHCH₃; and n is 0.

In one embodiment, for any fragrance composition comprising a compound of Formula I, R₁ is CH₃; R₂ is O; and n is 0.

In one embodiment, for any fragrance composition comprising a compound of Formula I, R₁ is CH₂CH₃; R₂ is CH₂; and n is 0.

In one embodiment, for any fragrance composition comprising a compound of Formula I, R₁ is CH₂CH₃; R₂ is CHCH₃; and n is 0.

In one embodiment, for any fragrance composition comprising a compound of Formula I, R₁ is CH₂CH₃; R₂ is O; and n is 0.

In one embodiment, for any fragrance composition comprising a compound of Formula I, R₁ is H; R₂ is CH₂; and n is 1.

In one embodiment, for any fragrance composition comprising a compound of Formula I, R₁ is H; R₂ is CHCH₃; and n is 1.

In one embodiment, for any fragrance composition comprising a compound of Formula I, R₁ is H; R₂ is O; and n is 1.

In one embodiment, for any fragrance composition comprising a compound of Formula I, R₁ is CH₃; R₂ is CH₂; and n is 1.

In one embodiment, for any fragrance composition comprising a compound of Formula I, R₁ is CH₃; R₂ is CHCH₃; and n is 1.

In one embodiment, for any fragrance composition comprising a compound of Formula I, R₁ is CH₃; R₂ is O; and n is 1.

In one embodiment, for any fragrance composition comprising a compound of Formula I, R₁ is CH₂CH₃; R₂ is CH₂; and n is 1.

In one embodiment, for any fragrance composition comprising a compound of Formula I, R₁ is CH₂CH₃; R₂ is CHCH₃; and n is 1.

In one embodiment, for any fragrance composition comprising a compound of Formula I, R₁ is CH₂CH₃; R₂ is O; and n is 1.

In one embodiment, for any fragrance composition comprising a compound of Formula I, R₁ is H; R₂ is CH₂; and n is 2.

In one embodiment, for any fragrance composition comprising a compound of Formula I, R₁ is H; R₂ is CHCH₃; and n is 2.

In one embodiment, for any fragrance composition comprising a compound of Formula I, R₁ is H; R₂ is O; and n is 2.

In one embodiment, for any fragrance composition comprising a compound of Formula I, R₁ is CH₃; R₂ is CH₂; and n is 2.

In one embodiment, for any fragrance composition comprising a compound of Formula I, R₁ is CH₃; R₂ is CHCH₃; and n is 2.

In one embodiment, for any fragrance composition comprising a compound of Formula I, R₁ is CH₃; R₂ is O; and n is 2.

In one embodiment, for any fragrance composition comprising a compound of Formula I, R₁ is CH₂CH₃; R₂ is CH₂; and n is 2.

In one embodiment, for any fragrance composition comprising a compound of Formula I, R₁ is CH₂CH₃; R₂ is CHCH₃; and n is 2.

In one embodiment, for any fragrance composition comprising a compound of Formula I, R₁ is CH₂CH₃; R₂ is O; and n is 2.

In one embodiment, for any fragrance composition comprising a compound of Formula I, R₁ is H; R₂ is CH₂; and n is 3.

In one embodiment, for any fragrance composition comprising a compound of Formula I, R₁ is H; R₂ is CHCH₃; and n is 3.

In one embodiment, for any fragrance composition comprising a compound of Formula I, R₁ is H; R₂ is O; and n is 3.

In one embodiment, for any fragrance composition comprising a compound of Formula I, R₁ is CH₃; R₂ is CH₂; and n is 3.

In one embodiment, for any fragrance composition comprising a compound of Formula I, R₁ is CH₃; R₂ is CHCH₃; and n is 3.

In one embodiment, for any fragrance composition comprising a compound of Formula I, R₁ is CH₃; R₂ is O; and n is 3.

In one embodiment, for any fragrance composition comprising a compound of Formula I, R₁ is CH₂CH₃; R₂ is CH₂; and n is 3.

In one embodiment, for any fragrance composition comprising a compound of Formula I, R₁ is CH₂CH₃; R₂ is CHCH₃; and n is 3.

In one embodiment, for any fragrance composition comprising a compound of Formula I, R₁ is CH₂CH₃; R₂ is O; and n is 3.

In one embodiment, for any fragrance composition comprising a compound of Formula I, R₁ is H; R₂ is CH₂; and n is 4.

In one embodiment, for any fragrance composition comprising a compound of Formula I, R₁ is H; R₂ is CHCH₃; and n is 4.

In one embodiment, for any fragrance composition comprising a compound of Formula I, R₁ is H; R₂ is O; and n is 4.

In one embodiment, for any fragrance composition comprising a compound of Formula I, R₁ is CH₃; R₂ is CH₂; and n is 4.

In one embodiment, for any fragrance composition comprising a compound of Formula I, R₁ is CH₃; R₂ is CHCH₃; and n is 4.

In one embodiment, for any fragrance composition comprising a compound of Formula I, R₁ is CH₃; R₂ is O; and n is 4.

In one embodiment, for any fragrance composition comprising a compound of Formula I, R₁ is CH₂CH₃; R₂ is CH₂; and n is 4.

In one embodiment, for any fragrance composition comprising a compound of Formula I, R₁ is CH₂CH₃; R₂ is CHCH₃; and n is 4.

In one embodiment, for any fragrance composition comprising a compound of Formula I, R₁ is CH₂CH₃; R₂ is O; and n is 4.

In one embodiment, for any fragrance composition comprising a compound of Formula I, R₁ is H; R₂ is CH₂; and n is 5.

In one embodiment, for any fragrance composition comprising a compound of Formula I, R₁ is H; R₂ is CHCH₃; and n is 5.

In one embodiment, for any fragrance composition comprising a compound of Formula I, R₁ is H; R₂ is O; and n is 5.

In one embodiment, for any fragrance composition comprising a compound of Formula I, R₁ is CH₃; R₂ is CH₂; and n is 5.

In one embodiment, for any fragrance composition comprising a compound of Formula I, R₁ is CH₃; R₂ is CHCH₃; and n is 5.

In one embodiment, for any fragrance composition comprising a compound of Formula I, R₁ is CH₃; R₂ is O; and n is 5.

In one embodiment, for any fragrance composition comprising a compound of Formula I, R₁ is CH₂CH₃; R₂ is CH₂; and n is 5.

In one embodiment, for any fragrance composition comprising a compound of Formula I, R₁ is CH₂CH₃; R₂ is CHCH₃; and n is 5.

In one embodiment, for any fragrance composition comprising a compound of Formula I, R₁ is CH₂CH₃; R₂ is O; and n is 5.

In one embodiment, for any fragrance composition comprising a compound of Formula I, R₁ is H; R₂ is CH₂; and n is 6.

In one embodiment, for any fragrance composition comprising a compound of Formula I, R₁ is H; R₂ is CHCH₃; and n is 6.

In one embodiment, for any fragrance composition comprising a compound of Formula I, R₁ is H; R₂ is O; and n is 6.

In one embodiment, for any fragrance composition comprising a compound of Formula I, R₁ is CH₃; R₂ is CH₂; and n is 6.

In one embodiment, for any fragrance composition comprising a compound of Formula I, R₁ is CH₃; R₂ is CHCH₃; and n is 6.

In one embodiment, for any fragrance composition comprising a compound of Formula I, R₁ is CH₃; R₂ is O; and n is 6.

In one embodiment, for any fragrance composition comprising a compound of Formula I, R₁ is CH₂CH₃; R₂ is CH₂; and n is 6.

In one embodiment, for any fragrance composition comprising a compound of Formula I, R₁ is CH₂CH₃; R₂ is CHCH₃; and n is 6.

In one embodiment, for any fragrance composition comprising a compound of Formula I, R₁ is CH₂CH₃; R₂ is O; and n is 6.

In one embodiment, for any fragrance composition comprising a compound of Formula I, the compound of Formula I imparts a fragrance to the fragrance composition.

In one aspect, the application relates to a fragrance composition comprising a compound of Formula II,

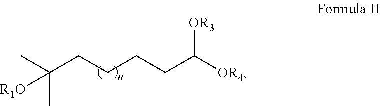

wherein:
R₁ is H, C₁₋₆ alkyl, or —C(O)C₁₋₆ alkyl;
R₃ and R₄ are each C₁₋₆ alkyl; and
n is an integer from 0 to 6.

In one embodiment, for any fragrance composition comprising a compound of Formula II, R₁ is H, CH₃, or CH₂CH₃. In one embodiment, R₁ is H. In one embodiment, R₁ is CH₃. In one embodiment, R₁ is CH₂CH₃.

In one embodiment, for any fragrance composition comprising a compound of Formula II, R₁ is iso-propyl, n-propyl, iso-butyl, sec-butyl, n-butyl, iso-pentyl, neo-pentyl, n-pentyl, tert-pentyl, sec-pentyl, 3-pentyl, n-hexyl, 2-methyl-pentyl, 3-methyl-pentyl, 2,3-dimethyl-butyl, or 2,2-dimethylbutyl.

In one embodiment, for any fragrance composition comprising a compound of Formula II, R₁ is —C(O)CH₃. In one embodiment, R₁ is —C(O)CH₂CH₃, —C(O)-n-propyl, —C(O)-iso-propyl, —C(O)-iso-butyl, —C(O)-sec-butyl, or —C(O)-n-butyl.

In one embodiment, for any fragrance composition comprising a compound of Formula II, R₃ and R₄ are the same. In one embodiment, R₃ and R₄ are different.

In one embodiment, for any fragrance composition comprising a compound of Formula II, R₃ and R₄ are both methyl. In one embodiment, R₃ and R₄ are both ethyl. In one embodiment, R₃ and R₄ are both n-propyl. In one embodiment, R₃ and R₄ are both iso-propyl. In one embodiment, R₃ and R₄ are both n-butyl.

In one embodiment, for any fragrance composition comprising a compound of Formula II, n is an integer from 1 to 6, from 2 to 6, from 3 to 6, from 4 to 6, from 5 to 6, from 0 to 5, from 1 to 5, from 2 to 5, from 3 to 5, from 4 to 5, from 0 to 4, from 1 to 4, from 2 to 4, from 3 to 4, from 0 to 3, from 1 to 3, from 2 to 3, from 0 to 2, from 1 to 2, from 0 to 1.

In one embodiment, for any fragrance composition comprising a compound of Formula II, n is 0, n is 1, n is 2, n is 3, n is 4, n is 5, or n is 6.

In one embodiment, for any fragrance composition comprising a compound of Formula II, R₁ is H and R₃ and R₄ are both methyl.

In one embodiment, for any fragrance composition comprising a compound of Formula II, R₁ is H and R₃ and R₄ are both ethyl.

In one embodiment, for any fragrance composition comprising a compound of Formula II, R₁ is CH₃ and R₃ and R₄ are both methyl.

In one embodiment, for any fragrance composition comprising a compound of Formula II, R₁ is CH₃ and R₃ and R₄ are both ethyl.

In one embodiment, for any fragrance composition comprising a compound of Formula II, R₁ is CH₂CH₃ and R₃ and R₄ are both methyl.

In one embodiment, for any fragrance composition comprising a compound of Formula II, R₁ is CH₂CH₃ and R₃ and R₄ are both ethyl.

In one embodiment, for any fragrance composition comprising a compound of Formula II, R₁ is H; R₃ and R₄ are both methyl; and n is 0.

In one embodiment, for any fragrance composition comprising a compound of Formula II, R₁ is H; R₃ and R₄ are both ethyl; and n is 0.

In one embodiment, for any fragrance composition comprising a compound of Formula II, R₁ is CH₃; R₃ and R₄ are both methyl; and n is 0.

In one embodiment, for any fragrance composition comprising a compound of Formula II, R₁ is CH₃; R₃ and R₄ are both ethyl; and n is 0.

In one embodiment, for any fragrance composition comprising a compound of Formula II, R₁ is CH₂CH₃; R₃ and R₄ are both methyl; and n is 0.

In one embodiment, for any fragrance composition comprising a compound of Formula II, R₁ is CH₂CH₃; R₃ and R₄ are both ethyl; and n is 0.

In one embodiment, for any fragrance composition comprising a compound of Formula II, R₁ is H; R₃ and R₄ are both methyl; and n is 1.

In one embodiment, for any fragrance composition comprising a compound of Formula II, R₁ is H; R₃ and R₄ are both ethyl; and n is 1.

In one embodiment, for any fragrance composition comprising a compound of Formula II, R₁ is CH₃; R₃ and R₄ are both methyl; and n is 1.

In one embodiment, for any fragrance composition comprising a compound of Formula II, R₁ is CH₃; R₃ and R₄ are both ethyl; and n is 1.

In one embodiment, for any fragrance composition comprising a compound of Formula II, R₁ is CH₂CH₃; R₃ and R₄ are both methyl; and n is 1.

In one embodiment, for any fragrance composition comprising a compound of Formula II, R₁ is CH₂CH₃; R₃ and R₄ are both ethyl; and n is 1.

In one embodiment, for any fragrance composition comprising a compound of Formula II, R₁ is H; R₃ and R₄ are both methyl; and n is 2.

In one embodiment, for any fragrance composition comprising a compound of Formula II, R₁ is H; R₃ and R₄ are both ethyl; and n is 2.

In one embodiment, for any fragrance composition comprising a compound of Formula II, R₁ is CH₃; R₃ and R₄ are both methyl; and n is 2.

In one embodiment, for any fragrance composition comprising a compound of Formula II, R₁ is CH₃; R₃ and R₄ are both ethyl; and n is 2.

In one embodiment, for any fragrance composition comprising a compound of Formula II, R₁ is CH₂CH₃; R₃ and R₄ are both methyl; and n is 2.

In one embodiment, for any fragrance composition comprising a compound of Formula II, R₁ is CH₂CH₃; R₃ and R₄ are both ethyl; and n is 2.

In one embodiment, for any fragrance composition comprising a compound of Formula II, R₁ is H; R₃ and R₄ are both methyl; and n is 3.

In one embodiment, for any fragrance composition comprising a compound of Formula II, R₁ is H; R₃ and R₄ are both ethyl; and n is 3.

In one embodiment, for any fragrance composition comprising a compound of Formula II, R₁ is CH₃; R₃ and R₄ are both methyl; and n is 3.

In one embodiment, for any fragrance composition comprising a compound of Formula II, R₁ is CH₃; R₃ and R₄ are both ethyl; and n is 3.

In one embodiment, for any fragrance composition comprising a compound of Formula II, R₁ is CH₂CH₃; R₃ and R₄ are both methyl; and n is 3.

In one embodiment, for any fragrance composition comprising a compound of Formula II, R₁ is CH₂CH₃; R₃ and R₄ are both ethyl; and n is 3.

In one embodiment, for any fragrance composition comprising a compound of Formula II, R₁ is H; R₃ and R₄ are both methyl; and n is 4.

In one embodiment, for any fragrance composition comprising a compound of Formula II, R₁ is H; R₃ and R₄ are both ethyl; and n is 4.

In one embodiment, for any fragrance composition comprising a compound of Formula II, R₁ is CH₃; R₃ and R₄ are both methyl; and n is 4.

In one embodiment, for any fragrance composition comprising a compound of Formula II, R₁ is CH₃; R₃ and R₄ are both ethyl; and n is 4.

In one embodiment, for any fragrance composition comprising a compound of Formula II, R₁ is CH₂CH₃; R₃ and R₄ are both methyl; and n is 4.

In one embodiment, for any fragrance composition comprising a compound of Formula II, R₁ is CH₂CH₃; R₃ and R₄ are both ethyl; and n is 4.

In one embodiment, for any fragrance composition comprising a compound of Formula II, R₁ is H; R₃ and R₄ are both methyl; and n is 5.

In one embodiment, for any fragrance composition comprising a compound of Formula II, R₁ is H; R₃ and R₄ are both ethyl; and n is 5.

In one embodiment, for any fragrance composition comprising a compound of Formula II, R₁ is CH₃; R₃ and R₄ are both methyl; and n is 5.

In one embodiment, for any fragrance composition comprising a compound of Formula II, R₁ is CH₃; R₃ and R₄ are both ethyl; and n is 5.

In one embodiment, for any fragrance composition comprising a compound of Formula II, R₁ is CH₂CH₃; R₃ and R₄ are both methyl; and n is 5.

In one embodiment, for any fragrance composition comprising a compound of Formula II, R₁ is CH₂CH₃; R₃ and R₄ are both ethyl; and n is 5.

In one embodiment, for any fragrance composition comprising a compound of Formula II, R₁ is H; R₃ and R₄ are both methyl; and n is 6.

In one embodiment, for any fragrance composition comprising a compound of Formula II, R₁ is H; R₃ and R₄ are both ethyl; and n is 6.

In one embodiment, for any fragrance composition comprising a compound of Formula II, R₁ is CH₃; R₃ and R₄ are both methyl; and n is 6.

In one embodiment, for any fragrance composition comprising a compound of Formula II, R₁ is CH₃; R₃ and R₄ are both ethyl; and n is 6.

In one embodiment, for any fragrance composition comprising a compound of Formula II, R₁ is CH₂CH₃; R₃ and R₄ are both methyl; and n is 6.

In one embodiment, for any fragrance composition comprising a compound of Formula II, R₁ is CH₂CH₃; R₃ and R₄ are both ethyl; and n is 6.

In one embodiment, for any fragrance composition comprising a compound of Formula II, the compound of Formula II imparts a fragrance to the fragrance composition.

In one aspect, the application relates to a fragrance composition comprising a compound of Formula III,

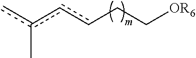

wherein:
R₆ is H, C₁₋₆ alkyl, or —C(O)C₁₋₆ alkyl;
m is and integer from 1 to 6; and
wherein at least one of the [symbol] is a double bond, and the remaining [symbol] are single bonds, provided that two adjacent [symbol] are not both double bonds.

In one embodiment, for any fragrance composition comprising a compound of Formula III, R₆ is H, CH₃, or CH₂CH₃. In one embodiment, R₆ is H. In one embodiment, R₆ is CH₃. In one embodiment, R₆ is CH₂CH₃.

In one embodiment, for any fragrance composition comprising a compound of Formula III, R₆ is iso-propyl, n-propyl, iso-butyl, sec-butyl, n-butyl, iso-pentyl, neo-pentyl, n-pentyl, tert-pentyl, sec-pentyl, 3-pentyl, n-hexyl, 2-methyl-pentyl, 3-methyl-pentyl, 2,3-dimethyl-butyl, or 2,2-dimethylbutyl.

In one embodiment, for any fragrance composition comprising a compound of Formula III, R₆ is —C(O)CH₃. In one embodiment, R₆ is —C(O)CH₂CH₃, —C(O)-n-propyl, —C(O)-iso-propyl, —C(O)-iso-butyl, —C(O)-sec-butyl, or —C(O)-n-butyl.

In one embodiment, for any fragrance composition comprising a compound of Formula III, m is an integer from 2 to 6, from 3 to 6, from 4 to 6, from 5 to 6, from 1 to 5, from 2 to 5, from 3 to 5, from 4 to 5, from 1 to 4, from 2 to 4, from 3 to 4, from 1 to 3, from 2 to 3, from 1 to 2.

In one embodiment, for any fragrance composition comprising a compound of Formula III, m is 1, m is 2, m is 3, m is 4, m is 5, or m is 6.

In one embodiment, for any fragrance composition comprising a compound of Formula III, R₆ is H and m is 1.

In one embodiment, for any fragrance composition comprising a compound of Formula III, R₆ is CH₃ and m is 1.

In one embodiment, for any fragrance composition comprising a compound of Formula III, R₆ is CH₂CH₃ and m is 1.

In one embodiment, for any fragrance composition comprising a compound of Formula III, R₆ is —C(O)CH₃ and m is 1.

In one embodiment, for any fragrance composition comprising a compound of Formula III, R₆ is H and m is 2.

In one embodiment, for any fragrance composition comprising a compound of Formula III, R₆ is CH₃ and m is 2.

In one embodiment, for any fragrance composition comprising a compound of Formula III, R₆ is CH₂CH₃ and m is 2.

In one embodiment, for any fragrance composition comprising a compound of Formula III, R₆ is —C(O)CH₃ and m is 2.

In one embodiment, for any fragrance composition comprising a compound of Formula III, R₆ is H and m is 3.

In one embodiment, for any fragrance composition comprising a compound of Formula III, R₆ is CH₃ and m is 3.

In one embodiment, for any fragrance composition comprising a compound of Formula III, R₆ is CH₂CH₃ and m is 3.

In one embodiment, for any fragrance composition comprising a compound of Formula III, R₆ is —C(O)CH₃ and m is 3.

In one embodiment, for any fragrance composition comprising a compound of Formula III, R₆ is H and m is 4.

In one embodiment, for any fragrance composition comprising a compound of Formula III, R₆ is CH₃ and m is 4.

In one embodiment, for any fragrance composition comprising a compound of Formula III, R₆ is CH₂CH₃ and m is 4.

In one embodiment, for any fragrance composition comprising a compound of Formula III, R₆ is —C(O)CH₃ and m is 4.

In one embodiment, for any fragrance composition comprising a compound of Formula III, R₆ is H and m is 5.

In one embodiment, for any fragrance composition comprising a compound of Formula III, R₆ is CH₃ and m is 5.

In one embodiment, for any fragrance composition comprising a compound of Formula III, R₆ is CH₂CH₃ and m is 5.

In one embodiment, for any fragrance composition comprising a compound of Formula III, R₆ is —C(O)CH₃ and m is 5.

In one embodiment, for any fragrance composition comprising a compound of Formula III, R₆ is H and m is 6.

In one embodiment, for any fragrance composition comprising a compound of Formula III, R₆ is CH₃ and m is 6.

In one embodiment, for any fragrance composition comprising a compound of Formula III, R₆ is CH₂CH₃ and m is 6.

In one embodiment, for any fragrance composition comprising a compound of Formula III, R₆ is —C(O)CH₃ and m is 6.

In one embodiment, for any fragrance composition comprising a compound of Formula III, the compound of Formula III imparts a fragrance to the fragrance composition.

In one aspect, the application relates to a fragrance composition comprising a compound selected from:

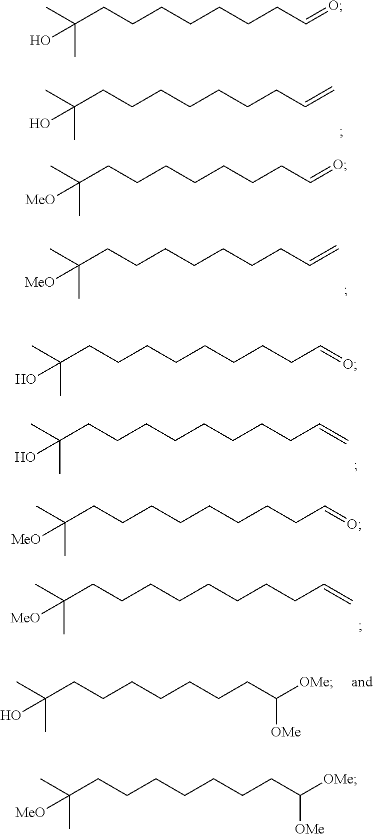

wherein the compound imparts a fragrance to the fragrance composition.

In one aspect, the application relates to a fragrance composition comprising 9-hydroxy-9-methyldecanal,

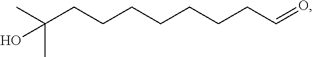

wherein the 9-hydroxy-9-methyldecanal imparts a fragrance to the fragrance composition.

In one aspect, the application relates to a fragrance composition comprising a compound of Formula I, Formula II, or Formula III, wherein the concentration of the compound of Formula I, Formula II, or Formula III is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound of Formula I, wherein the concentration of the compound of Formula I is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound of Formula II, wherein the concentration of the compound of Formula II is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound of Formula III, wherein the concentration of the compound of Formula III is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound selected from:

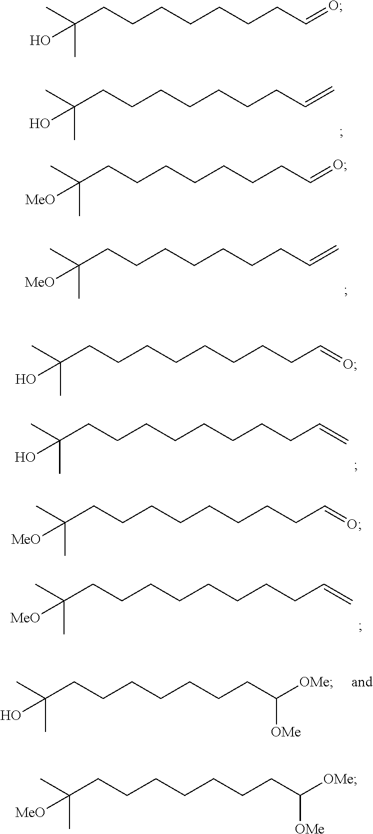

wherein the concentration of the compound is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising 9-hydroxy-9-methyldecanal,

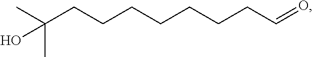

wherein the concentration of 9-hydroxy-9-methyldecanal is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

In one aspect, the application relates to a fragrance composition comprising a compound of Formula I, Formula II, or Formula III, wherein the composition further comprises one or more additives, one or more fragrance ingredients, or a combination thereof.

In one embodiment, the fragrance composition comprising a compound of Formula I, Formula II, or Formula III, comprises at least one additive. In one embodiment, the additive comprises a surfactant.

In one embodiment, the fragrance composition comprising a compound of Formula I, Formula II, or Formula III, comprises at least one fragrance ingredient. In one embodiment, the fragrance ingredient comprises an oil.

In one embodiment, the fragrance composition comprising a compound of Formula I, Formula II, or Formula III, comprises at least one additive and at least one fragrance ingredient.

In one embodiment, the fragrance composition comprising a compound of Formula I, Formula II, or Formula III is for use in a perfume, air freshener, laundry detergent, household cleaning product, liquid or bar soap, shampoo, conditioner, hair spray, cosmetic, makeup, deodorant, insect repellant, insecticide, or pet litter.

In one embodiment, the fragrance composition comprising a compound of Formula I, Formula II, or Formula III is for use in a perfume, parfum, extrait, Esprit de Parfum, Parfum de Toilette, Eau de Toilette, or Eau de Cologne.

In one embodiment, the fragrance composition comprising a compound of Formula I, Formula II, or Formula III is for use in an air freshener, e.g., a spray, candle, oil, bead, wax melt, plug-in, fabric refresher, or car air freshener.

In one embodiment, the fragrance composition comprising a compound of Formula I, Formula II, or Formula III is for use in a household or industrial cleaning product. In one embodiment, the household cleaner is bleach, a shower/bath cleaning product, a toilet-cleaning product, a glass-cleaning product, a tile-cleaning product, a wood-cleaning product, a carpet-cleaning product, or a granite-cleaning product. In one embodiment, the industrial cleaner is an all-purpose cleaner, a high-performance cleaner, or a degreaser.

In one embodiment, the fragrance composition comprising a compound of Formula I, Formula II, or Formula III is for use in a cosmetic, make up, or make product.

In one embodiment, the fragrance composition comprising a compound of Formula I, Formula II, or Formula III is for use in health and personal care products, e.g., after shave, deodorant, medical spray (athlete's foot), sunscreen, sunburn treatment, wrinkle cream, exfoliator, scrub, moisturizer, lotion, powder, hand soap, hand sanitizer, bar soap, liquid soap, body wash, shampoo, conditioner, baby shampoo, baby oil, acne bar soap, acne cream, and acne gel.

In one embodiment, the fragrance composition comprising a compound of Formula I, Formula II, or Formula III is for use in pet litter.

In one aspect, the application relates to a fragrance composition comprising 9-hydroxy-9-methyldecanal, wherein the composition further comprises one or more additives, one or more fragrance ingredients, or a combination thereof.

In one embodiment, the fragrance composition comprising 9-hydroxy-9-methyldecanal, comprises at least one additive. In one embodiment, the additive comprises a surfactant.

In one embodiment, the fragrance composition comprising 9-hydroxy-9-methyldecanal, comprises at least one fragrance ingredient. In one embodiment, the fragrance ingredient comprises an oil.

In one embodiment, the fragrance composition comprising 9-hydroxy-9-methyldecanal, comprises at least one additive and at least one fragrance ingredient.

In one embodiment, the fragrance composition comprising 9-hydroxy-9-methyldecanal is for use in a perfume, air freshener, laundry detergent, household cleaning product, liquid or bar soap, shampoo, conditioner, hair spray, cosmetic, makeup, deodorant, insect repellant, insecticide, or pet litter.

In one embodiment, the fragrance composition comprising 9-hydroxy-9-methyldecanal is for use in a perfume, parfum, extrait, Esprit de Parfum, Parfum de Toilette, Eau de Toilette, or Eau de Cologne.

In one embodiment, the fragrance composition comprising 9-hydroxy-9-methyldecanal is for use in an air freshener, e.g., a spray, candle, oil, bead, wax melt, plug-in, fabric refresher, or car air freshener.

In one embodiment, the fragrance composition comprising 9-hydroxy-9-methyldecanal is for use in a household or industrial cleaning product. In one embodiment, the household cleaner is bleach, a shower/bath cleaning product, a toilet-cleaning product, a glass-cleaning product, a tile-cleaning product, a wood-cleaning product, a carpet-cleaning product, or a granite-cleaning product. In one embodiment, the industrial cleaner is an all-purpose cleaner, a high-performance cleaner, or a degreaser.

In one embodiment, the fragrance composition comprising 9-hydroxy-9-methyldecanal is for use in a cosmetic, make up, or make up products.

In one embodiment, the fragrance composition comprising 9-hydroxy-9-methyldecanal is for use in health and personal care products, e.g., after shave, deodorant, medical spray (athlete's foot), sunscreen, sunburn treatment, wrinkle creams, exfoliator, scrub, moisturizer, lotion, powder, hand soap, hand sanitizer, bar soap, liquid soap, body wash, shampoo, conditioner, baby shampoo, baby oil, acne bar soap, acne cream, and acne gel.

In one embodiment, the fragrance composition comprising 9-hydroxy-9-methyldecanal is for use in pet litter.

As used herein, the term “fragrance composition” means a mixture of fragrance ingredients, including auxiliary substances if desired, dissolved in a suitable solvent or mixed with a powdery substrate used to provide a desired odor to a product. Examples of products having fragrance compositions include, but are not limited to, perfumes, parfum, extrait, Esprit de Parfum, Parfum de Toilette, Eau de Toilette, Eau de Cologne, soaps, insect repellants and insecticides, detergents, household and industrial cleaning products, air fresheners, room sprays, pomanders, candles, cosmetics, makeup, health and personal care products, toilet waters, pre- and aftershave lotions, talcum powders, hair-care products, body deodorants, anti-perspirants, and pet litter.

Fragrance ingredients and mixtures of fragrance ingredients that may be used in combination with the disclosed compound for the manufacture of fragrance compositions include, but are not limited to, natural products including extracts, animal products and essential oils, absolutes, resinoids, resins, and concretes, and synthetic fragrance materials which include, but are not limited to, alcohols, aldehydes, ketones, ethers, acids, esters, acetals, phenols, ethers, lactones, furans, ketals, nitriles, acids, and hydrocarbons, including both saturated and unsaturated compounds and aliphatic carbocyclic and heterocyclic compounds, and animal products. As used herein, the term “fragrance ingredient” refers to ingredients other than compounds of Formula I, Formula II, or Formula III, e.g., 9-hydroxy-9-methyldecanal. The application is directed to fragrance compositions comprising compounds of Formula I, Formula II, or Formula III, e.g., 9-hydroxy-9-methyldecanal. Compounds of Formula I, Formula II, or Formula III, e.g., 9-hydroxy-9-methyldecanal, may be considered for use as a novel fragrance ingredient owing to their desirable fragrance properties. For clarity, compounds of Formula I, Formula II, or Formula III, e.g., 9-hydroxy-9-methyldecanal, are referred to by name or by “the compound” or “the compounds” of the application to differentiate it from known fragrance ingredients used in fragrance compositions.

Examples of esters which may be used in the fragrance compositions of the present application include, but are not limited to, acrylic acid esters (methyl, ethyl, etc.), acetoacetic acid esters (methyl, ethyl, etc.), anisic acid esters (methyl, ethyl, etc.), benzoic acid esters (allyl, isoamyl, ethyl, geranyl, linalyl, phenylethyl, hexyl, cis-3-hexenyl, benzyl, methyl, etc.), anthranilic acid esters (cinnamyl, cis-3-hexenyl, methyl, ethyl, linalyl, isobutyl, etc.), N-methylanthranilic acid esters (methyl, ethyl, etc.), isovaleric acid esters (amyl, allyl, isoamyl, isobutyl, isopropyl, ethyl, octyl, geranyl, cyclohexyl, citronellyl, terpenyl, linalyl, cinnamyl, phenylethyl, butyl, propyl, hexyl, benzyl, methyl, rhodinyl, etc.), isobutyric acid esters (isoamyl, geranyl, citronellyl, terpenyl, cinnamyl, octyl, nellyl, phenylethyl, phenylpropyl, phenoxyethyl, butyl, propyl, isopropyl, hexyl, benzyl, methyl, ethyl, linalyl, rhodinyl, etc.), undecylenic acid esters (allyl, isoamyl, butyl, ethyl, methyl, etc.), octanoic acid esters (allyl, isoamyl, ethyl, octyl, hexyl, butyl, methyl, linalyl, etc.), octenoic acid esters (methyl, ethyl, etc.), octynecarboxylic acid esters (methyl, ethyl, etc.), caproic acid esters (allyl, amyl, isoamyl, methyl, ethyl, isobutyl, propyl, hexyl, cis-3-hexenyl, trans-2-hexenyl, linalyl, geranyl, cyclohexyl, etc.), hexenoic acid esters (methyl, ethyl, etc.), valeric acid esters (amyl, isopropyl, isobutyl, ethyl, cis-3-hexenyl, trans-2-hexenyl, cinnamyl, phenylethyl, methyl, etc.), formic acid esters (anisyl, isoamyl, isopropyl, ethyl, octyl, geranyl, citronellyl, cinnamyl, cyclohexyl, terpenyl, phenylethyl, butyl, propyl, hexyl, cis-3-hexenyl, benzyl, linalyl, rhodinyl, etc.), crotonic acid esters (isobutyl, ethyl, cyclohexyl, etc.), cinnamic acid esters (allyl, ethyl, methyl, isopropyl, propyl, 3-phenylpropyl, benzyl, cyclohexyl, methyl, etc.), succinic acid esters (monomenthyl, diethyl, dimethyl, etc.), acetic acid esters (anisyl, amyl, α-amylcinnamyl, isoamyl, isobutyl, isopropyl, isobornyl, isoeugenyl, eugenyl, 2-ethylbutyl, ethyl, 3-octyl, p-cresyl, o-cresyl, geranyl, α- or β-santalyl, cyclohexyl, cycloneryl, dihydrocuminyl, dimethyl benzyl carbinyl, cinnamyl, styralyl, decyl, dodecyl, terpenyl, guainyl, neryl, nonyl, phenyl ethyl, phenylpropyl, butyl, furfuryl, propyl, hexyl, cis-3-hexenyl, trans-2-hexenyl, cis-3-nonenyl, cis-6-noneyl, cis-3-cis-6-nonadienyl, 3-methyl-2-butenyl, heptyl, benzyl, bomyl, myrcenyl, dihydromyrcenyl, myrtenyl, methyl, 2-methylbutyl, menthyl, linalyl, rhodinyl, etc.), salicylic acid esters (allyl, isoamyl, phenyl, phenylethyl, benzyl, ethyl, methyl, etc.), cyclohexylalkanoic acid esters (ethyl cyclohexylacetate, allyl cyclohexylpropionate, allyl cyclohexylbutyrate, allyl cyclohexylhexanoate, allyl cyclohexyldecanoate, allyl cyclohexylvalerate, etc.), stearic acid esters (ethyl, propyl, butyl, etc.), sebacic acid esters (diethyl, dimethyl, etc.), decanoic acid esters (isoamyl, ethyl, butyl, methyl, etc.), dodecanoic acid esters (isoamyl, ethyl, butyl, etc.), lactic acid esters (isoamyl, ethyl, butyl, etc.), nonanoic acid esters (ethyl, phenylethyl, methyl, etc.), nonenoic acid esters (allyl, ethyl, methyl, etc.), hydroxyhexanoic acid esters (ethyl, methyl, etc.), phenylacetic acid esters (isoamyl, isobutyl, ethyl, geranyl, citronellyl, cis-3-hexenyl, methyl, etc.), phenoxyacetic acid esters (allyl, ethyl, methyl, etc.), furancarboxylic acid esters (ethyl furancarboxylate, methyl furancarboxylate, hexyl furancarboxylate, isobutyl furaneopentyl glycol diacetateropionate, etc.), propionic acid esters (anisyl, allyl, ethyl, amyl, isoamyl, propyl, butyl, isobutyl, isopropyl, benzyl, geranyl, cyclohexyl, citronellyl, cinnamyl, tetrahydrofurfuryl, tricyclodecenyl, heptyl, bornyl, methyl, menthyl, linallyl, terpenyl, α-methylpropionyl, β-methylpropionyl, etc.), heptanoic acid esters (allyl, ethyl, octyl, propyl, methyl, etc.), heptinecarboxylic acid esters (allyl, ethyl, propyl, methyl, etc.), myristic acid esters (isopropyl, ethyl, methyl, etc.), phenylglycidic acid esters (ethyl phenylglycidate, ethyl 3-methylphenylglycidate, ethyl p-methyl-β-phenylglycidate, etc.), 2-methylbutyric acid esters (methyl, ethyl, octyl, phenyl ethyl, butyl, hexyl, benzyl, etc.), 3-methylbutyric acid esters (methyl, ethyl, etc.), butyric acid esters (anisyl, amyl, allyl, isoamyl, methyl, ethyl, propyl, octyl, guainyl, linallyl, geranyl, cyclohexyl, citronellyl, cinnamyl, nellyl, terpenyl, phenylpropyl, β-phenylethyl, butyl, hexyl, cis-3-hexenyl, trans-2-hexenyl, benzyl, rhodinyl, etc.), and hydroxybutyric acid esters (methyl, ethyl, menthyl or the like of 3-hydroxybutyric acid esters).

Examples of alcohols that may be used in the fragrance compositions of the present application include, but are not limited to, aliphatic alcohols (isoamyl alcohol, 2-ethylhexanol, 1-octanol, 3-octanol, 1-octene-3-ol, 1-decanol, 1-dodecanol, 2,6-nonadienol, nonanol, 2-nonanol, cis-6-nonenol, trans-2, cis-6-nonadienol, cis-3, cis-6-nonadienol, butanol, hexanol, cis-3-hexenol, trans-2-hexenol, 1-undecanol, heptanol, 2-heptanol, 3-methyl-1-pentanol, etc.); terpene alcohols (borneol, isobomeol, carveol, geraniol, α- or β-santalol, citronellol, 4-thujanol, terpineol, 4-terpineol, nerol, myrcenol, myrtenol, dihydromyrccnol, tetrahydromyrcenol, nerolidol, hydroxycitronellol, farnesol, perilla alcohol, rhodinol, linalool, etc.); and aromatic alcohols (anisic alcohol, α-amylcinnamic alcohol, isopropylbenzylcarbinol, carvacrol, cumin alcohol, dimethylbenzylcarbinol, cinnamic alcohol, phenyl allyl alcohol, phenylethylcarbinol, 3-phenylethyl alcohol, 3-phenylpropyl alcohol, benzyl alcohol, etc.).

Examples of aldehydes that may be used in the fragrance compositions of the present application include, but are not limited to, aliphatic aldehydes (acetaldehyde, octanal, nonanal, decanal, undecanal, 2,6-dimethyl-5-heptanal, 3,5,5-trimethylhexanal, cis-3, cis-6-nonadienal, trans-2, cis-6-nonadienal, valeraldehyde, propanal, isopropanal, hexanal, trans-2-hexenal, cis-3-hexenal, 2-pentenal, dodecanal, tetradecanal, trans-4-decenal, trans-2-tridecenal, trans-2-dodecenal, trans-2-undecenal, 2,4-hexadienal, cis-6-nonenal, trans-2-nonenal, 2-methylbutanal, etc.); aromatic aldehydes (anisic aldehyde, α-amylcinnamic aldehyde, α-methylcinnamic aldehyde, cyclamen aldehyde, p-isopropylphenylacetaldehyde, ethylvanillin, cumin aldehyde, salicylaldehyde, cinnamic aldehyde, o-, m- or p-tolylaldehyde, vanillin, piperonal, phenylacetaldehyde, heliotropin, benzaldehyde, 4-methyl-2-pheny-2-pentenal, p-methoxycinnamic aldehyde, p-methoxybenzaldehyde, etc.); and terpene aldehydes (geranial, citral, citronellal, α-sinensal, β-sinensal, perillaldehyde, hydroxycitronellal, tetrahydrocitral, myrtenal, cyclocitral, isocyclocitral, citronellyloxyacetaldehyde, neral, α-methylenecitronellal, myracaldehyde, vemaldehyde, safranal, etc.).

Examples of ketones which may be used in the fragrance compositions of the application include, but are not limited to, cyclic ketones (1-acetyl-3,3-dimethyl-1-cyclohexene, cis-jasmone, α-, β- or γ-irone, ethyl maltol, cyclotene, dihydronootkatone, 3,4-dimethyl-1,2-cyclopentadione, sotolon, α-, β-, γ- or 6-damascone, α-, β- or γ-damascenone, nootkatone, 2-sec-butylcyclohexanone, maltol, α-, β- or γ-ionone, α-, β- or γ-methylionone, α-, β- or γ-isomethylionone, furaneol, camphor, etc.); aromatic ketones (acetonaphthone, acetophenone, anisylideneacetone, raspberry ketone, p-methyl acetophenone, anisylacetone, p-methoxy acetophenone, etc.); and chain ketones (diacetyl, 2-nonanone, diacetyl, 2-heptanone, 2,3-heptanedione, 2-pentanone, methyl amyl ketone, methyl nonyl ketone, β-methyl naphthyl ketone, methyl heptanone, 3-heptanone, 4-heptanone, 3-octanone, 2,3-hexanedione, 2-undecanone, dimethyloctenone, 6-methyl-5-hepten-2-one, etc.).

Examples of acetals which may be used in the fragrance compositions of the present application include, but are not limited to, acetaldehyde diethyl acetal, acetaldehyde diamyl acetal, acetaldehyde dihexyl acetal, acetaldehyde propylene glycol acetal, acetaldehyde ethyl cis-3-hexenyl acetal, benzaldehyde glycerin acetal, benzaldehyde propylene glycol acetal, citral dimethyl acetal, citral diethyl acetal, citral propylene glycol acetal, citral ethylene glycol acetal, phenylacetaldehyde dimethyl acetal, citronellyl methyl acetal, acetaldehyde phenylethylpropyl acetal, hexanal dimethyl acetal, hexanal dihexyl acetal, hexanal propylene glycol acetal, trans-2-hexenal diethyl acetal, trans-2-hexenal propylene glycol acetal, cis-3-hexenal diethyl acetal, heptanal diethyl acetal, heptanal ethylene glycol acetal, octanal dimethyl acetal, nonanal dimethyl acetal, decanal dimethyl acetal, decanal diethyl acetal, 2-methylundecanal dimethyl acetal, citronellal dimethyl acetal, Ambersage (manufactured by Givaudan), ethyl acetoacetate ethylene glycol acetal, and 2-phenylpropanal dimethyl acetal.

Examples of phenols which may be used in the fragrance compositions of the present application include, but are not limited to, eugenol, isoeugenol, 2-methoxy-4-vinylphenol, thymol, carvacrol, guaiacol, and chavicol, and vanillin.

Examples of ethers which may be used in the fragrance compositions of the present application include, but are not limited to, anethole, 1,4-cineole, dibenzyl ether, linalool oxide, limonene oxide, nerol oxide, rose oxide, methyl isoeugenol, methyl chavicol, isoamyl phenyl ethyl ether, β-naphtyl methyl ether, phenyl propyl ether, p-cresyl methyl ether, vanillyl butyl ether, α-terpinyl methyl ether, citronellyl ethyl ether, geranyl ethyl ether, rosefuran, theaspirane, decylmethyl ether, and methylphenyl methyl ether.

Examples of lactones which may be used in the fragrance compositions of the application include, but are not limited to, γ- or δ-decalactone, γ-heptalactone, γ-nonalactone, γ- or δ-hexylactone, γ- or δ-octalactone, γ- or δ-undecalactone, δ-dodecalactone, δ-2-decenolactone, methyl lactone, 5-hydroxy-8-undecenoic acid δ-lactone, jasmine lactone, menthalactone, dihydrocoumarin, octahydrocoumarin, and 6-methylcoumarin.

Examples of furans which may be used in the fragrance compositions of the present application include, but are not limited to, furan, 2-methylfuran, 3-methylfuran, 2-ethylfuran, 2,5-diethyltetrahydrofuran, 3-hydroxy-2-methyltetrahydrofuran, 2-(methoxymethyl)furan, 2,3-dihydrofuran, furfural, 5-methylfurfural, 3-(2-furyl)-2-methyl-2-propenal, 5-(hydroxymethyl)furfural, 2,5-dimethyl-4-hydroxy-3(2H)-furanone (furaneol), 4,5-dim ethyl-3-hydroxy-2(5H)-furanone (sotolon), 2-ethyl-4-hydroxy-5-methyl-3(2H)-furanone (homofuraneol), 5-ethyl-3-hydroxy-4-methyl-2(5H)-furanone (homosotolon), 3-methyl-1,2-cyclopentanedione (cyclotene), 2(5H)-furanone, 4-methyl-2(5H)-furanone, 5-methyl-2(5H)-furanone, 2-methyl-3(2H)-furanone, 5-methyl-3(2H)-furanone, 2-acetylfuranone, 2-acetyl-5-methylfuran, furfuryl alcohol, methyl 2-furancarboxylate, ethyl 2-furancarboxylate, and furfuryl acetate.

Examples of hydrocarbons which may be used in the fragrance compositions of the present application include, but are not limited to, α- or β-bisabolene, β-caryophyllene, p-cymene, terpinene, terpinolene, cadinene, cedrene, longifolene, farnesene, limonene, ocimene, myrcene, α- or β-pinene, 1,3,5-undecatriene and valencene.

Examples of acids that may be used in the fragrance compositions of the present application include, but are not limited to, geranic acid, dodecanoic acid, myristic acid, stearic acid, lactic acid, phenylacetic acid, pyruvic acid, trans-2-methyl-2-pentenoic acid, 2-methyl-cis-3-pentenoic acid, 2-methyl-4-pentenoic acid, and cyclohexanecarboxylic acid.

The fragrance compositions of the application may comprise one or more natural extracts or oils including, but not limited to, anise, orange, lemon, lime, mandarin, petitgrain, bergamot, lemon balm, grapefruit, elemi, olibanum, lemongrass, neroli, marjoram, angelica root, star anise, basil, bay, calamus, chamomile, caraway, cardamom, cassia, cinnamon, pepper, perilla, cypress, oregano, cascarilla, ginger, parsley, pine needle, sage, hyssop, tea tree, mustard, horseradish, clary sage, clove, cognac, coriander, estragon, eucalyptus, fennel, guaiac wood, dill, cajuput, wormseed, pimento, juniper, fenugreek, garlic, laurel, mace, myrrh, nutmeg, spruce, geranium, citronella, lavender, lavandin, palmarosa, rose, rosemary, sandalwood, oakmoss, cedarwood, vetiver, linaloe, bois de rose, patchouli, labdanum, cumin, thyme, ylang ylang, birch, capsicum, celery, tolu balsam, genet, immortelle, benzoin, jasmine, cassie, tuberose, reseda, marigold, mimosa, opoponax, orris, vanilla and licorice. Each of these natural extracts or oils comprises a complex mixture of chemical compounds, which may include those compounds described above. Additional fragrance ingredients may be isolated from natural products, for example, geraniol and citronellal may be isolated from citronella oil, citral may be isolated from lemon-grass oil, eugenol may be isolated from clove oil, and linalool may be isolated from rosewood oil. Animal products used in fragrance compositions include, but are not limited to, musk, ambergris, civet and castoreum. The natural ingredients described herein may also be produced synthetically, and may include the compounds disclosed herein, and be used as fragrance ingredients in the fragrance compositions of the present application.

Examples of fragrance ingredients used in perfumes, air fresheners, laundry detergents, pet litters, cleaning products, liquid and bar soaps, shampoos and conditioners, cosmetics, deodorants, and personal hygiene products include, but are not limited to, hexyl cinnamic aldehyde; amyl cinnamic aldehyde; amyl salicylate; hexyl salicylate; terpineol; 3,7-dimethyl-cis-2,6-octadien-1-ol; 2,6-dimethyl-2-octanol; 2,6-dimethyl-7-octen-2-ol; 3,7-dimethyl-3-octanol; 3,7-dimethyl-trans-2,6-octadien-1-ol; 3,7-dimethyl-6-octen-1-ol; 3,7-dimethyl-1-octanol; 2-methyl-3-(para-tert-butylphenyl)-propionaldehyde; 4-(4-hydroxy-4-methylpentyl)-3-cyclohexene-1-carboxaldehyde; tricyclodecenyl propionate; tricyclodecenyl acetate; anisaldehyde; 2-methyl-2-(para-iso-propylphenyl)-propionaldehyde; ethyl-3-methyl-3-phenyl glycidate; 4-(para-hydroxyphenyl)-butan-2-one; 1-(2,6,6-trimethyl-2-cyclohexen-1-yl)-2-buten-1-one; para-methoxyacetophenone; para-methoxy-alpha-phenylpropene; methyl-2-n-hexyl-3-oxo-cyclopentane carboxylate; undecalactone gamma, geraniol; geranyl acetate; linalool; linalyl acetate; tetrahydrolinalool; citronellol; citronellyl acetate; dihydromyrcenol; dihydromyrcenyl acetate; tetrahydromyrcenol; terpinyl acetate; nopol; nopyl acetate; 2-phenylethanol; 2-phenylethyl acetate; benzyl alcohol; benzyl acetate; benzyl salicylate; benzyl benzoate; styrallyl acetate; dimethylbenzylcarbinol; trichloromethylphenylcarbinyl methylphenylcarbinyl acetate; isononyl acetate; vetiveryl acetate; vetiverol; 2-methyl-3-(p-tert-butylphenyl)-propanal; 2-methyl-3-(p-isopropylphenyl)-propanal; 3-(p-tert-butylphenyl)-propanal; 4-(4-methyl-3-pentenyl)-3-cyclohexenecarbaldehyde; 4-acetoxy-3-pentyltetrahydropyran; methyl dihydrojasmonate; 2-n-heptylcyclopentanone; 3-methyl-2-pentyl-cyclopentanone; n-decanal; n-dodecanal; 9-decenol-1; phenoxyethyl isobutyrate; phenylacetaldehyde dimethylacetal; phenylacetaldehyde diethylacetal; geranonitrile; citronellonitrile; cedryl acetal; 3-isocamphylcyclohexanol; cedryl methylether; isolongifolanone; aubepine nitrile; aubepine; heliotropine; eugenol; vanillin; diphenyl oxide; hydroxycitronellal ionones; methyl ionones; isomethyl ionomes; irones; cis-3-hexenol and esters thereof; indane musk fragrances; tetralin musk fragrances; isochroman musk fragrances; macrocyclic ketones; macrolactone musk fragrances; and ethylene brassylate.

The fragrance ingredients in a given product's fragrance composition is selected based on the intended use of the product and the product's desired aroma.

In one aspect, a fragrance composition is provided comprising a compound of Formula I, Formula II, or Formula III, e.g., 9-hydroxy-9-methyldecanal. In some embodiments, the fragrance composition may further comprise one or more additives, one or more fragrance ingredients, or a combination thereof.

In one aspect, a fragrance composition is provided comprising one or more compounds of Formula I, Formula II, or Formula III. In some embodiments, the fragrance composition may further comprise one or more additives, one or more fragrance ingredients, or a combination thereof.

In accordance with embodiments, a product is provided comprising a fragrance composition wherein the fragrance composition comprises a compound of Formula I, Formula II, or Formula III, e.g., 9-hydroxy-9-methyldecanal. In some embodiments, the product may contain an additional substance, including but not limited to an excipient or a buffer.

In accordance with embodiments, a product is provided comprising a fragrance composition wherein the fragrance composition comprises one or more compounds of Formula I, Formula II, or Formula III. In some embodiments, the product may contain an additional substance, including but not limited to an excipient or a buffer.

The amount of a given fragrance ingredient in a fragrance composition cannot be categorically described because it varies depending on the type product being scented, the intended use of the product, and the desired aroma of the product. The amount of a fragrance ingredient in a fragrance composition is usually in the range of from about 1% to about 99% by mass of the fragrance composition. When the amount of the ingredient is too small, a sufficient strength of the scent may not be obtained. Further, when the amount of the ingredient is too large, a larger amount of the agent(s) needed to solubilize the ingredient may be needed, which may in turn reduce the desired aromatic properties of the end product by inhibiting volatilization or other mechanisms by which the fragrance is dispersed when the product is used or consumed. The amount of each of the fragrance ingredients in a given fragrance composition must therefore be selected based upon the aromatic characteristics of the selected ingredient, the overall composition of the product, and the intended aromatic effect.

Additives may be used in the fragrance compositions of the application. Additives that may be used include, but are not limited to, solvents and surfactants. Other fragrance composition additives will be selected in accordance with the intended use of the composition.

Solvents, for example water-soluble organic solvents, which may be used in the fragrance compositions of the application include, but are not limited to, ethanol, propanol, isopropanol, butanol, 3-methoxy-3-methyl-1-butanol, benzyl alcohol, ethyl carbitol (diethylene glycol monoethyl ether), ethylene glycol, propylene glycol, dipropylene glycol, butylene glycol, hexylene glycol, glycerin, ethylene glycol monomethyl ether, propylene glycol monomethyl ether, propylene glycol monoethyl ether, and dipropylene glycol monomethyl ether. These water-soluble solvents may be used solely or in combination.

The content of the water-soluble organic solvent in the compositions of the application may be determined according to the desired composition properties, and is usually from about 1% to about 99% by mass. In one embodiment, the content of the water-soluble solvent is from about 1% to about 10% by mass, from about 5% to about 15% by mass, from about 10% to about 20% by mass, from about 15% to about 25% by mass, from about 20% to about 30% by mass, from about 25% to about 35% by mass, from about 30% to about 40% by mass, from about 35% to about 45% by mass, from about 40% to about 50% by mass, from about 45% to about 55% by mass, from about 50% to about 60% by mass, from about 55% to about 65% by mass, from about 60% to about 70% by mass, from about 75% to about 85% by mass, from about 80% to about 90% by mass, from about 85% to about 95% by mass, from about 90% to about 99% by mass, or from about 95% to about 99% by mass.

The content of the water-soluble organic solvent in the compositions of the application may be determined according to the desired composition properties, and, in one embodiment, the content of the water-soluble solvent is 99% by mass, 98% by mass, 97% by mass, 96% by mass, 95% by mass, 94% by mass, 93% by mass, 92% by mass, 91% by mass, 90% by mass, 89% by mass, 88% by mass, 87% by mass, 86% by mass, 85% by mass, 84% by mass, 83% by mass, 82% by mass, 81% by mass, 80% by mass, 79% by mass, 78% by mass, 77% by mass, 76% by mass, 75% by mass, 74% by mass, 73% by mass, 72% by mass, 71% by mass, 70% by mass, 69% by mass, 68% by mass, 67% by mass, 66% by mass, 65% by mass, 64% by mass, 63% by mass, 62% by mass, 61% by mass, 60% by mass, 59% by mass, 58% by mass, 57% by mass, 56% by mass, 55% by mass, 54% by mass, 53% by mass, 52% by mass, 51% by mass, 50% by mass, 49% by mass, 48% by mass, 47% by mass, 46% by mass, 45% by mass, 44% by mass, 43% by mass, 42% by mass, 41% by mass, 40% by mass, 39% by mass, 38% by mass, 37% by mass, 36% by mass, 35% by mass, 34% by mass, 33% by mass, 32% by mass, 31% by mass, 30% by mass, 29% by mass, 28% by mass, 27% by mass, 26% by mass, 25% by mass, 24% by mass, 23% by mass, 22% by mass, 21% by mass, 20% by mass, 19% by mass, 18% by mass, 17% by mass, 16% by mass, 15% by mass, 14% by mass, 13% by mass, 12% by mass, 11% by mass, 10% by mass, 9% by mass, 8% by mass, 7% by mass, 6% by mass, 5% by mass, 4% by mass, 3% by mass, 2% by mass, or 1% by mass.

Oil-soluble organic solvents which may be used with the fragrance compositions of the application include, but are not limited to, isoparaffin, paraffin, limonene, pinene, triethyl citrate, benzyl benzoate, isopropyl myristate, triacetin, and silicon.

Preferred solvents include, but are not limited to, triethyl citrate, triacetin, glycerol, ethanol, water, triglycerides, liquid waxes, propylene glycol derivatives, and ethylene glycol derivatives.

The fragrance compositions of the present application may be used in combination with other substances, including, but not limited to, sequestering agents, preservatives, antioxidants, deodorizers, sterilization agents, ultraviolet absorbers, pH adjusters, insecticidal components, components for protection from insects, insect repellents, colorants, excipients, and buffers. The substances used in, or in addition to, the fragrance compositions of the present application may be determined by the product in which the composition is included. When the substance is used in a fragrance composition, it may be an additive. When the substance is used alongside a fragrance composition, it may be considered as part of a product composition that comprises a fragrance composition.

Excipients that may be used in the fragrance compositions of the present application may vary depending on the use of the intended product and its overall composition. In some instances, the excipient may be included in the fragrance composition or may, alternatively, be independent of the composition. In pet litter, a solid excipient comprised of cellulosic or chlorophyll-containing agents or other materials may be used. In contrast, cosmetic excipients may include, but are not limited to, carbopol 940 ETD, triethanolamine, purified water, glycerine, imidazolidinyl urea, EDTA, 1polyvinyl alcohol, methyl parabenes phenoxyethanol 0, ethyl alcohol 1, peg 7 glyceryl cocoate, peg 6 triglyceryl caproic glycerides, acemulogar LAM V, isopropyhlyristate, tegosoft CT, zantham gum, sepicide CL, polyquaternum 7, and Vaseline oils. Additional suitable excipients for use with or in a fragrance composition for a given product will be readily selected by those having ordinary skill in the art.

Buffers that may be used with the fragrance compositions of the present application may vary depending on the use of the intended product and its overall composition. In some instances, the buffer may be included in the fragrance composition or may, alternatively, be independent of the composition. Examples of buffers that may be used in or with the fragrance compositions of the application include, but are not limited to, citrates, acetates, and phosphates. For example, in cosmetic products, disodium hydrogen phosphate, potassium dihydrogenphosphate, disodium hydrogenphosphate and, and citric acid may be used to buffer the pH of the product. Additional suitable buffers for use with or in a fragrance composition for a given product will be readily selected by those having ordinary skill in the art.

The fragrance compositions of the application may contain a compound of Formula I, Formula II, or Formula III in a range of concentrations, for example, in one embodiment, from about 0.0005% to about 99.9% by mass a compound of Formula I, Formula II, or Formula III with about 99.9995% to about 0.1% by mass of one or more additives and/or other fragrance ingredients. In one embodiment, a fragrance composition comprising about 0.0005% to about 10% by mass a compound of Formula I, Formula II, or Formula III may be combined with about 99.9995% to about 90% by mass of one or more additives and/or other fragrance ingredients. In one embodiment, a fragrance composition comprising about 0.0005% to about 1% by mass a compound of Formula I, Formula II, or Formula III may be combined with about 99.9995% to about 99% by mass of one or more additives and/or other fragrance ingredients. In one embodiment, a fragrance composition comprising about 0.05% to about 50% by mass a compound of Formula I, Formula II, or Formula III may be combined with about 99.95% to about 50% by mass of one or more additives and/or other fragrance ingredients. In one embodiment, a fragrance composition comprising about 0.05% to about 10% by mass a compound of Formula I, Formula II, or Formula III may be combined with about 99.95% to about 90% by mass of one or more additives and/or other fragrance ingredients. In one embodiment, a fragrance composition comprising about 0.05% to about 1% by mass a compound of Formula I, Formula II, or Formula III may be combined with about 99.95% to about 99% by mass of one or more additives and/or other fragrance ingredients. In one embodiment, a fragrance composition comprising about 0.5% to about 50% by mass a compound of Formula I, Formula II, or Formula III may be combined with about 99.5% to about 50% by mass of one or more additives and/or other fragrance ingredients. In one embodiment, a fragrance composition comprising about 0.5% to about 10% by mass a compound of Formula I, Formula II, or Formula III may be combined with about 99.5% to about 90% by mass of one or more additives and/or other fragrance ingredients. In one embodiment, a fragrance composition comprising about 0.5% to about 5% by mass a compound of Formula I, Formula II, or Formula III may be combined with about 99.5% to about 95% by mass of one or more additives and/or other fragrance ingredients. In one embodiment, a fragrance composition comprising about 0.5% to about 2.5% by mass a compound of Formula I, Formula II, or Formula III may be combined with about 99.5% to about 97.5% by mass of one or more additives and/or fragrance ingredients. In one embodiment, a fragrance composition comprising about 2.5% to about 5% by mass a compound of Formula I, Formula II, or Formula III may be combined with about 97.5% to about 95% by mass of one or more additives and/or fragrance ingredients. In one embodiment, a fragrance composition comprising about 5% to about 7.5% by mass a compound of Formula I, Formula II, or Formula III may be combined with about 95% to about 92.5% by mass of one or more additives and/or fragrance ingredients. In one embodiment, a fragrance composition comprising about 7.5% to about 10% by mass a compound of Formula I, Formula II, or Formula III may be combined with about 92.5% to about 90% by mass of one or more additives and/or fragrance ingredients. In one embodiment, a fragrance composition comprising about 10% to about 20% by mass a compound of Formula I, Formula II, or Formula III may be combined with about 90% to about 80% by mass of one or more additives and/or other fragrance ingredients. In one embodiment, a fragrance composition comprising about 20% to about 30% by mass a compound of Formula I, Formula II, or Formula III may be combined with about 80% to about 70% by mass of one or more additives and/or other fragrance ingredients. In one embodiment, a fragrance composition comprising about 30% to about 40% by mass a compound of Formula I, Formula II, or Formula III may be combined with about 70% to about 60% by mass of one or more additives and/or other fragrance ingredients. In one embodiment, a fragrance composition comprising about 40% to about 50% by mass a compound of Formula I, Formula II, or Formula III may be combined with about 60% to about 50% by mass of one or more additives and/or other fragrance ingredients. In one embodiment, a fragrance composition comprising about 50% to about 60% by mass a compound of Formula I, Formula II, or Formula III may be combined with about 50% to about 40% by mass of one or more additives and/or other fragrance ingredients. In one embodiment, a fragrance composition comprising about 60% to about 70% by mass a compound of Formula I, Formula II, or Formula III may be combined with about 40% to about 30% by mass of one or more additives and/or other fragrance ingredients. In one embodiment, a fragrance composition comprising about 70% to about 80% by mass a compound of Formula I, Formula II, or Formula III may be combined with about 30% to about 20% by mass of one or more additives and/or other fragrance ingredients. In one embodiment, a fragrance composition comprising about 80% to about 90% by mass a compound of Formula I, Formula II, or Formula III may be combined with about 20% to about 10% by mass of one or more additives and/or other fragrance ingredients. In one embodiment, a fragrance composition comprising about 85% to about 95% by mass a compound of Formula I, Formula II, or Formula III may be combined with about 15% to about 5% by mass of one or more additives and/or other fragrance ingredients. In one embodiment, a fragrance composition comprising about 90% to about 99.5% by mass a compound of Formula I, Formula II, or Formula III may be combined with about 10% to about 0.5% by mass of one or more additives and/or other fragrance ingredients. In one embodiment, a fragrance composition comprising about 90% to about 98% by mass a compound of Formula I, Formula II, or Formula III may be combined with about 10% to about 8% by mass of one or more additives and/or other fragrance ingredients. In one embodiment, a fragrance composition comprising about 90% to about 95% by mass a compound of Formula I, Formula II, or Formula III may be combined with about 10% to about 5% by mass of one or more additives and/or other fragrance ingredients.

The fragrance compositions of the application may contain 9-hydroxy-9-methyldecanal in a range of concentrations, for example, in one embodiment, from about 0.0005% to about 99.9% by mass 9-hydroxy-9-methyldecanal with about 99.9995% to about 0.1% by mass of one or more additives and/or other fragrance ingredients. In one embodiment, a fragrance composition comprising about 0.0005% to about 10% by mass 9-hydroxy-9-methyldecanal may be combined with about 99.9995% to about 90% by mass of one or more additives and/or other fragrance ingredients. In one embodiment, a fragrance composition comprising about 0.0005% to about 1% by mass 9-hydroxy-9-methyldecanal may be combined with about 99.9995% to about 99% by mass of one or more additives and/or other fragrance ingredients. In one embodiment, a fragrance composition comprising about 0.05% to about 50% by mass 9-hydroxy-9-methyldecanal may be combined with about 99.95% to about 50% by mass of one or more additives and/or other fragrance ingredients. In one embodiment, a fragrance composition comprising about 0.05% to about 10% by mass 9-hydroxy-9-methyldecanal may be combined with about 99.95% to about 90% by mass of one or more additives and/or other fragrance ingredients. In one embodiment, a fragrance composition comprising about 0.05% to about 1% by mass 9-hydroxy-9-methyldecanal may be combined with about 99.95% to about 99% by mass of one or more additives and/or other fragrance ingredients. In one embodiment, a fragrance composition comprising about 0.5% to about 50% by mass 9-hydroxy-9-methyldecanal may be combined with about 99.5% to about 50% by mass of one or more additives and/or other fragrance ingredients. In one embodiment, a fragrance composition comprising about 0.5% to about 10% by mass 9-hydroxy-9-methyldecanal may be combined with about 99.5% to about 90% by mass of one or more additives and/or other fragrance ingredients. In one embodiment, a fragrance composition comprising about 0.5% to about 5% by mass 9-hydroxy-9-methyldecanal may be combined with about 99.5% to about 95% by mass of one or more additives and/or other fragrance ingredients. In one embodiment, a fragrance composition comprising about 0.5% to about 2.5% by mass 9-hydroxy-9-methyldecanal may be combined with about 99.5% to about 97.5% by mass of one or more additives and/or fragrance ingredients. In one embodiment, a fragrance composition comprising about 2.5% to about 5% by mass 9-hydroxy-9-methyldecanal may be combined with about 97.5% to about 95% by mass of one or more additives and/or fragrance ingredients. In one embodiment, a fragrance composition comprising about 5% to about 7.5% by mass 9-hydroxy-9-methyldecanal may be combined with about 95% to about 92.5% by mass of one or more additives and/or fragrance ingredients. In one embodiment, a fragrance composition comprising about 7.5% to about 10% by mass 9-hydroxy-9-methyldecanal may be combined with about 92.5% to about 90% by mass of one or more additives and/or fragrance ingredients. In one embodiment, a fragrance composition comprising about 10% to about 20% by mass 9-hydroxy-9-methyldecanal may be combined with about 90% to about 80% by mass of one or more additives and/or other fragrance ingredients. In one embodiment, a fragrance composition comprising about 20% to about 30% by mass 9-hydroxy-9-methyldecanal may be combined with about 80% to about 70% by mass of one or more additives and/or other fragrance ingredients. In one embodiment, a fragrance composition comprising about 30% to about 40% by mass 9-hydroxy-9-methyldecanal may be combined with about 70% to about 60% by mass of one or more additives and/or other fragrance ingredients. In one embodiment, a fragrance composition comprising about 40% to about 50% by mass 9-hydroxy-9-methyldecanal may be combined with about 60% to about 50% by mass of one or more additives and/or other fragrance ingredients. In one embodiment, a fragrance composition comprising about 50% to about 60% by mass 9-hydroxy-9-methyldecanal may be combined with about 50% to about 40% by mass of one or more additives and/or other fragrance ingredients. In one embodiment, a fragrance composition comprising about 60% to about 70% by mass 9-hydroxy-9-methyldecanal may be combined with about 40% to about 30% by mass of one or more additives and/or other fragrance ingredients. In one embodiment, a fragrance composition comprising about 70% to about 80% by mass 9-hydroxy-9-methyldecanal may be combined with about 30% to about 20% by mass of one or more additives and/or other fragrance ingredients. In one embodiment, a fragrance composition comprising about 80% to about 90% by mass 9-hydroxy-9-methyldecanal may be combined with about 20% to about 10% by mass of one or more additives and/or other fragrance ingredients. In one embodiment, a fragrance composition comprising about 85% to about 95% by mass 9-hydroxy-9-methyldecanal may be combined with about 15% to about 5% by mass of one or more additives and/or other fragrance ingredients. In one embodiment, a fragrance composition comprising about 90% to about 99.5% by mass 9-hydroxy-9-methyldecanal may be combined with about 10% to about 0.5% by mass of one or more additives and/or other fragrance ingredients. In one embodiment, a fragrance composition comprising about 90% to about 98% by mass 9-hydroxy-9-methyldecanal may be combined with about 10% to about 8% by mass of one or more additives and/or other fragrance ingredients. In one embodiment, a fragrance composition comprising about 90% to about 95% by mass 9-hydroxy-9-methyldecanal may be combined with about 10% to about 5% by mass of one or more additives and/or other fragrance ingredients.

The compositions of the application comprising a compound of Formula I, Formula II, or Formula III in a range of concentrations may possess a pleasant scent and be useful in the preparation of fragrance compositions.

In one aspect, the compositions of the application comprise a compound of Formula I, Formula II, or Formula III at 0.005% by mass, 0.01% by mass, 0.02% by mass, 0.03% by mass, 0.04% by mass, 0.05% by mass, 0.06% by mass, 0.07% by mass, 0.08% by mass, 0.09% by mass, 0.1% by mass, 0.2% by mass, 0.3% by mass, 0.4% by mass, 0.5% by mass, 0.6% by mass, 0.7% by mass, 0.8% by mass, 0.9% by mass, 1% by mass, 2% by mass, 3% by mass, 4% by mass, 5% by mass, 6% by mass, 7% by mass, 8% by mass, 9% by mass, 10% by mass, 11% by mass, 12% by mass, 13% by mass, 14% by mass, 15% by mass, 16% by mass, 17% by mass, 18% by mass, 19% by mass, 20% by mass, 21% by mass, 22% by mass, 23% by mass, 24% by mass, 25% by mass, 26% by mass, 27% by mass, 28% by mass, 29% by mass, 30% by mass, 31% by mass, 32% by mass, 33% by mass, 34% by mass, 35% by mass, 36% by mass, 37% by mass, 38% by mass, 39% by mass, 40% by mass, 41% by mass, 42% by mass, 43% by mass, 44% by mass, 45% by mass, 46% by mass, 47% by mass, 48% by mass, 49% by mass, 50% by mass, 51% by mass, 52% by mass, 53% by mass, 54% by mass, 55% by mass, 56% by mass, 57% by mass, 58% by mass, 59% by mass, 60% by mass, 61% by mass, 62% by mass, 63% by mass, 64% by mass, 65% by mass, 66% by mass, 67% by mass, 68% by mass, 69% by mass, 70% by mass, 71% by mass, 72% by mass, 73% by mass, 75% by mass, 76% by mass, 77% by mass, 78% by mass, 79% by mass, 80% by mass, 81% by mass, 82% by mass, 83% by mass, 84% by mass, 85% by mass, 86% by mass, 87% by mass, 88% by mass, 89% by mass, 90% by mass, 91% by mass, 92% by mass, 93% by mass, 94% by mass, 95% by mass, 96% by mass, 97% by mass, 98% by mass, or 99% by mass.

In one aspect, the compositions of the application comprise 9-hydroxy-9-methyldecanal at 0.005% by mass, 0.01% by mass, 0.02% by mass, 0.03% by mass, 0.04% by mass, 0.05% by mass, 0.06% by mass, 0.07% by mass, 0.08% by mass, 0.09% by mass, 0.1% by mass, 0.2% by mass, 0.3% by mass, 0.4% by mass, 0.5% by mass, 0.6% by mass, 0.7% by mass, 0.8% by mass, 0.9% by mass, 1% by mass, 2% by mass, 3% by mass, 4% by mass, 5% by mass, 6% by mass, 7% by mass, 8% by mass, 9% by mass, 10% by mass, 11% by mass, 12% by mass, 13% by mass, 14% by mass, 15% by mass, 16% by mass, 17% by mass, 18% by mass, 19% by mass, 20% by mass, 21% by mass, 22% by mass, 23% by mass, 24% by mass, 25% by mass, 26% by mass, 27% by mass, 28% by mass, 29% by mass, 30% by mass, 31% by mass, 32% by mass, 33% by mass, 34% by mass, 35% by mass, 36% by mass, 37% by mass, 38% by mass, 39% by mass, 40% by mass, 41% by mass, 42% by mass, 43% by mass, 44% by mass, 45% by mass, 46% by mass, 47% by mass, 48% by mass, 49% by mass, 50% by mass, 51% by mass, 52% by mass, 53% by mass, 54% by mass, 55% by mass, 56% by mass, 57% by mass, 58% by mass, 59% by mass, 60% by mass, 61% by mass, 62% by mass, 63% by mass, 64% by mass, 65% by mass, 66% by mass, 67% by mass, 68% by mass, 69% by mass, 70% by mass, 71% by mass, 72% by mass, 73% by mass, 75% by mass, 76% by mass, 77% by mass, 78% by mass, 79% by mass, 80% by mass, 81% by mass, 82% by mass, 83% by mass, 84% by mass, 85% by mass, 86% by mass, 87% by mass, 88% by mass, 89% by mass, 90% by mass, 91% by mass, 92% by mass, 93% by mass, 94% by mass, 95% by mass, 96% by mass, 97% by mass, 98% by mass, or 99% by mass.

Compounds of Formula I and Formula III may be prepared as described in International Publication No. PCT/US2015/044012, which is incorporated herein in its entirety. For example, 9-hydroxy-9-methyldecanal can be prepared in two steps from methyl oleate. First, methyl oleate is reaction with 2 equivalents of methylmagnesium bromide to provide (Z)-2-methylnonadec-10-en-2-ol. This alcohol was cooled in water and reacted under standard ozonolysis conditions to provide 9-hydroxy-9-methyldecanal.

Compounds of Formula II, e.g., 10,10-dimethoxy-2-methyldecan-2-ol, can be prepared from the corresponding aldehyde by heating the aldehyde in a methanol solvent using a catalytic amount of protic acid, e.g., p-toluenesulfonic acid. Use of a dehydrating agent or other means of water removal will drive the equilibrium of the reaction towards the dimethyl acetal product. Other acetals can be prepared in the same way using a different alcoholic solvent, e.g., ethanol for diethyl acetal.

The details of one or more embodiments of the application are set forth in the accompanying description below. Unless defined otherwise, all technical and scientific terms used herein have the same meaning as commonly understood by one of ordinary skill in the art to which this application belongs. In the case of conflict, the present specification will control.

Unless otherwise indicated, it is to be understood that the terminology used herein is for the purpose of describing particular embodiments only and is not intended to be limiting. In this specification and in the claims that follow, reference will be made to a number of terms, which shall be defined to have the definitions set forth below.

As used herein, the singular forms “a,” “an,” and “the” include plural referents unless the context clearly dictates otherwise. Thus, for example, reference to “a reactant” includes not only a single reactant but also a combination or mixture of two or more different reactant, reference to “a substituent” includes a single substituent as well as two or more substituents, and the like.

As used herein, the phrases “for example,” “for instance,” “such as,” or “including” are meant to introduce examples that further clarify more general subject matter. These examples are provided only as an aid for understanding the disclosure, and are not meant to be limiting in any fashion. Furthermore as used herein, the terms “may,” “optional,” “optionally,” or “may optionally” mean that the subsequently described circumstance may or may not occur, so that the description includes instances where the circumstance occurs and instances where it does not. For example, the phrase “optionally present” means that an object may or may not be present, and, thus, the description includes instances wherein the object is present and instances wherein the object is not present.

The term “about,” when used to describe one of the compositions of the application, refers to a recited percentage ±5%, ±4%, ±3%, ±2.5%, ±2%, ±1.5%, ±1%, ±0.75%, ±0.5%, ±0.25%, or ±0.1%. In one embodiment, the term “about,” refers to a recited percentage ±5%. For example, “about 50%” refers to the range 45% to 55%. In one embodiment, the term “about,” refers to a recited percentage ±2.5%. In one embodiment, the term “about,” refers to a recited percentage ±1%. In one embodiment, the term “about,” refers to a recited percentage ±0.5%. In one embodiment, the term “about,” refers to a recited percentage ±0.1%.

As used herein, the phrase “having the formula” or “having the structure” is not intended to be limiting and is used in the same way that the term “comprising” is commonly used.

“Isomerism” means compounds that have identical molecular formulae but differ in the sequence of bonding of their atoms or in the arrangement of their atoms in space. Isomers that differ in the arrangement of their atoms in space are termed “stereoisomers”. Stereoisomers that are not mirror images of one another are termed “diastereoisomers”, and stereoisomers that are non-superimposable mirror images of each other are termed “enantiomers” or sometimes optical isomers. A mixture containing equal amounts of individual enantiomeric forms of opposite chirality is termed a “racemic mixture”.

A carbon atom bonded to four nonidentical substituents is termed a “chiral center.”

“Chiral isomer” means a compound with at least one chiral center. Compounds with more than one chiral center may exist either as an individual diastereomer or as a mixture of diastereomers, termed “diastereomeric mixture.” When one chiral center is present, a stereoisomer may be characterized by the absolute configuration (R or S) of that chiral center. Absolute configuration refers to the arrangement in space of the substituents attached to the chiral center. The substituents attached to the chiral center under consideration are ranked in accordance with the Sequence Rule of Cahn, Ingold and Prelog. (Cahn et al., Angew. Chem. Inter. Edit. 1966, 5, 385; errata 511; Cahn et al., Angew. Chem. 1966, 78, 413; Cahn and Ingold, J. Chem. Soc. 1951 (London), 612; Cahn et al., Experientia 1956, 12, 81; Cahn, J. Chem. Educ. 1964, 41, 116). In some formulae of the present application, one or more chiral centers are identified by an asterisk placed next to the chiral carbon. In other formulae, no chiral center is identified, but the chiral isomers are nonetheless covered by these formulae.

“Geometric isomer” means the diastereomers that owe their existence to hindered rotation about double bonds. These configurations are differentiated in their names by the prefixes cis and trans, or Z and E, which indicate that the groups are on the same or opposite side of the double bond in the molecule according to the Cahn-Ingold-Prelog rules.

Some compounds of the present application can exist in a tautomeric form which is also intended to be encompassed within the scope of the present application. “Tautomers” refers to compounds whose structures differ markedly in arrangement of atoms, but which exist in easy and rapid equilibrium. It is to be understood that the compounds of the application may be depicted as different tautomers. It should also be understood that when compounds have tautomeric forms, all tautomeric forms are intended to be within the scope of the application, and the naming of the compounds does not exclude any tautomeric form. Further, even though one tautomer may be described, the present application includes all tautomers of the present compounds.

As used herein, the term “salt” can include acid addition salts including hydrochlorides, hydrobromides, phosphates, sulfates, hydrogen sulfates, alkylsulfonates, arylsulfonates, acetates, benzoates, citrates, maleates, fumarates, succinates, lactates, and tartrates; alkali metal cations such as Na⁺, K⁺, Li⁺, alkali earth metal salts such as Mg²⁺ or Ca²⁺, or organic amine salts, or organic phosphonium salts.

The term “alkyl” as used herein refers to a monovalent or bivalent, branched or unbranched saturated hydrocarbon group typically although not necessarily containing 1 to about 20 carbon atoms, such as methyl, ethyl, n-propyl, isopropyl, n-butyl, isobutyl, t-butyl, octyl, and the like.

The term “alkenyl” as used herein refers to a monovalent or bivalent, branched or unbranched, unsaturated hydrocarbon group typically although not necessarily containing 2 to about 20 carbon atoms and 1-10 carbon-carbon double bonds, such as ethylene, n-propylene, isopropylene, n-butylene, isobutylene, t-butylene, octylene, and the like.

The term “alkynyl” as used herein refers to a monovalent or bivalent, branched or unbranched, unsaturated hydrocarbon group typically although not necessarily containing 2 to about 20 carbon atoms and 1-10 carbon-carbon triple bonds, such as ethyne, propyne, butyne, pentyne, hexyne, heptyne, octyne, and the like.

By “substituted” as in “substituted alkyl,” “substituted alkenyl,” “substituted alkynyl,” and the like, it is meant that in the alkyl, alkenyl, alkynyl, or other moiety, at least one hydrogen atom bound to a carbon atom is replaced with one or more non-hydrogen substituents, e.g., by a functional group.

Examples of functional groups include, without limitation: halo, hydroxyl, sulfhydryl, C₁-C₂₄ alkoxy, C₂-C₂₄ alkenyloxy, C₂-C₂₄ alkynyloxy, C₅-C₂₀ aryloxy, acyl (including C₂-C₂₄ alkylcarbonyl (—CO-alkyl) and C₆-C₂₀ arylcarbonyl (—CO-aryl)), acyloxy (—O-acyl), C₂-C₂₄ alkoxycarbonyl (—(CO)—O-alkyl), C₆-C₂₀ aryloxycarbonyl (—(CO)—O-aryl), halocarbonyl (—CO)—X where X is halo), C₂-C₂₄ alkylcarbonato (—O—(CO)—O-alkyl), C₆-C₂₀ arylcarbonato (—O—(CO)—O-aryl), carboxy (—COOH), carboxylato (—COO—), carbamoyl (—(CO)—NH₂), mono-substituted C₁-C₂₄ alkylcarbamoyl (—(CO)—NH(C₁-C₂₄ alkyl)), di-substituted alkylcarbamoyl (—(CO)—N(C₁-C₂₄ alkyl)₂), mono-substituted arylcarbamoyl (—(CO)—NH-aryl), thiocarbamoyl (—(CS)—NH₂), carbamido (—NH—(CO)—NH₂), cyano (—C≡N), isocyano (—N⁺≡C⁻), cyanato (—O—C≡N), isocyanato (—O—N⁺≡C⁻), isothiocyanato (—S—C≡N), azido (—N═N⁺≡N⁻), formyl (—(CO)—H), thioformyl (—(CS)—H), amino (—NH₂), mono- and di-(C₁-C₂₄ alkyl)-substituted amino, mono- and di-(C₅-C₂₀ aryl)-substituted amino, C₂-C₂₄ alkylamido (—NH—(CO)-alkyl), C₅-C₂₀ arylamido (—NH—(CO)-aryl), imino (—CR═NH where R=hydrogen, C₁-C₂₄ alkyl, C₅-C₂₀ aryl, C₆-C₂₀ alkaryl, C₆-C₂₀ aralkyl, etc.), alkylimino (—CR═N(alkyl), where R=hydrogen, alkyl, aryl, alkaryl, etc.), arylimino (—CR═N(aryl), where R=hydrogen, alkyl, aryl, alkaryl, etc.), nitro (—NO₂), nitroso (—NO), sulfo (—SO₂—OH), sulfonato (—SO₂—O—), C₁-C₂₄ alkylsulfanyl (—S-alkyl; also termed “alkylthio”), arylsulfanyl (—S-aryl; also termed “arylthio”), C₁-C₂₄ alkylsulfinyl (—(SO)-alkyl), C₅-C₂₀ arylsulfinyl (—(SO)-aryl), C₁-C₂₄ alkylsulfonyl (—SO₂-alkyl), C₅-C₂₀ arylsulfonyl (—SO₂-aryl), phosphono (—P(O)(OH)₂), phosphonato (—P(O)(O⁻)₂), phosphinato (—P(O)(O⁻)), phospho (—PO₂),-phosphino (—PH₂), mono- and di-(C₁-C₂₄ alkyl)-substituted phosphino, mono- and di-(C₅-C₂₀ aryl)-substituted phosphino; and the hydrocarbyl moieties such as C₁-C₂₄ alkyl (including C₁-C₁₈ alkyl, further including C₁-C₁₂ alkyl, and further including C₁-C₆ alkyl), C₂-C₂₄ alkenyl (including C₂-C₁₈ alkenyl, further including C₂-C₁₂ alkenyl, and further including C₂-C₆ alkenyl), C₂-C₂₄ alkynyl (including C₂-C₁₈ alkynyl, further including C₂-C₁₂ alkynyl, and further including C₂-C₆ alkynyl), C₅-C₃₀ aryl (including C₅-C₂₀ aryl, and further including C₅-C₁₂ aryl), and C₆-C₃₀ aralkyl (including C₆-C₂₀ aralkyl, and further including C₆-C₁₂ aralkyl). In addition, the aforementioned functional groups may, if a particular group permits, be further substituted with one or more additional functional groups or with one or more hydrocarbyl moieties such as those specifically enumerated above.

In the present specification, the structural formula of the compound represents a certain isomer for convenience in some cases, but the present application includes all isomers, such as geometrical isomers, optical isomers based on an asymmetrical carbon, stereoisomers, tautomers, and the like. In addition, a crystal polymorphism may be present for the compounds represented by the formula. It is noted that any crystal form, crystal form mixture, or anhydride or hydrate thereof is included in the scope of the present application.

### EXAMPLES

Compounds of Formula I and Formula III may be prepared as described in International Publication No. PCT/US2015/044012, which is incorporated herein in its entirety.

### Example 1: Synthesis of (Z)-2-methylnonadec-10-en-2-ol

Under nitrogen, 208 mL of methylmagnesium bromide solution (3M in THF from Sigma-Aldrich) was added slowly into methyl oleate (74 g, 0.25 mol) in THF (800 mL) at 0° C. over the course of 30 minutes. After stirring for 30 minutes at 0° C., the reaction was removed from the cooling bath and stirred for another 30 minutes. TLC showed all the starting material was consumed. The reaction was cooled down to 0° C. and quenched with saturated ammonium chloride. All the organic solvent (THF) was evaporated and 200 mL acetic acid (15% by vol. in water) was added into the mixture. The reaction mixture was extracted 2× with ethyl acetate (200 ml) and evaporation of the organic phase gave crude fatty alcohol product (90 g) that was taken on as is.

### (Z)-2-methylnonadec-10-en-2-ol

¹H NMR (CDCl₃, 400 MHz) δ 0.88 (t, J=7.2 Hz, 3H, —CH₃), 1.20 (s, 6H, —CH₃), 1.25-1.34 (m, 20H, —CH₂—), 1.43-1.47 (m, 2H, —CH₂—), 1.99-2.04 (m, 4H, —CH₂—), 5.29-5.41 (m, 2H, ═CH—).

### Example 2: Synthesis of 9-hydroxy-9-methyldecanal

A mixture of fatty alcohol (85 g) and water (255 g) were cooled to 20° C. in a jacketed reactor while stirring. A 2-6% by weight stream of 03 in 02 was diffused into the mixture at a flow rate of 10 L/min for 120 minutes, while highest reaction temperature was 26° C. during the process. The reaction vessel was then purged with N₂ and the reaction mixture was transferred into a high-pressure reactor and charged with Palladium black (213 mg). The reaction mixture was stirred under hydrogen atmosphere (350 psi) at 45-50° C. for 180 minutes until all peroxide had been consumed according to a titrated starch-iodine test. The reaction mixture was then cooled down and filtered to remove the catalyst and the filtrate was placed in a separatory funnel. The organic phase was separated. The aqueous phase was extracted 2× with ethyl acetate (200 ml) and the organic phase was concentrated to remove solvent. The crude product was washed with sodium carbonate (10% by wt.) until the PH=8 of the aqueous phase. Vacuum distillation (2″ wiped film, short-path distillation) gave clean product 12.7 g.

### 9-hydroxy-9-methyldecanal

¹H NMR (CDCl₃, 500 MHz) δ 1.19 (d, J=1.0 Hz, 6H, —CH₃), 1.31-1.35 (m, 8H, —CH₂—), 1.42-1.46 (m, 2H, —CH₂—), 1.59-1.64 (m, 2H, —CH₂—), 2.39-2.43 (m, 2H, —CH₂—), 9.75-9.76 (m, 1H, —COH).

### Example 3: Synthesis of methyl dec-9-enoate

Under nitrogen, potassium t-butoxide (13.1 g, 116 mmol) was added portion-wise into a suspension of methyltriphenylphosphonium bromide (41.6 g, 116 mmol) in THF (200 mL) at room temperature over the course of 10 minutes. The mixture was stirred for 1 hour at 50° C., and then cooled down to 0° C. and to add methyl 9-oxononanoate (10.8 g, 58 mmol) in THF (50 mL) slowly through syringe over 5 minutes. The cooling bath was removed and the reaction mixture was stirred for another 2 hours at room temperature. Saturated ammonium chloride solution (50 mL) was added slowly into the mixture to quench the reaction. Phases separated and the organic phase was collected. The aqueous phase was extracted 2× with ethyl acetate (200 ml) and all the organic phases were combined and concentrated to remove solvent. Column chromatograph gave 4.8 g of methyl dec-9-enoate in good purity (silica gel, EtOAc/heptane: 0-3% by vol.).

### methyl dec-9-enoate

¹H NMR (CDCl₃, 500 MHz) δ 1.25-1.40 (m, 8H, —CH₂), 1.59-1.65 (m, 2H, CH₂), 2.01-2.05 (m, 2H, —CH₂—), 2.30 (t, J=7.5 Hz, 2H, —CH₂—), 3.66 (s, 3H, —OCH₃), 4.91-5.00 (m, 2H, —CH₂—), 5.76-5.83 (m, 2H, ═CH₂).

### Example 4: Synthesis of 2-methylundec-10-en-2-ol

Under nitrogen, 14 mL of Methylmagnesium bromide solution (3M in THF from Sigma-Aldrich) was added slowly into methyl dec-9-enoate (3.1 g, 16.8 mmol) in THF (50 mL) at 0° C. during 5 minutes. After stirring for 30 minutes at 0° C., removed the cooling bath and stirred for another 1.5 hours. TLC showed all the starting materials were consumed. Cooled down the reaction to 0° C. and quenched with saturated ammonium chloride. Evaporated all the organic solvent (THF) and added 40 mL acetic acid (15% in water by vol.) into the mixture. The aqueous layer (150 mL+50 mL) was extracted with ethyl acetate 2× (150 ml, then 50 ml) and all the organic phases were combined and concentrated to remove solvent. 1.1 g of 2-methylundec-10-en-2-ol was then obtained following column chromatography in good purity (silica gel, EtOAc/heptane: 3-7.5% by vol.).

### 2-methylundec-10-en-2-ol

¹H NMR (CDCl₃, 500 MHz) δ 1.25 (s, 6H, —CH₃), 1.30-1.41 (m, 10H, CH₂), 1.43-1.48 (m, 2H, CH₂), 2.01-2.07 (m, 2H, —CH₂—), 4.91-5.02 (m, 2H, ═CH₂), 5.76-5.86 (m, 1H, ═CH—).

### Example 5: General Procedure for the Synthesis of Compounds of Formula II

Compounds of Formula II can be prepared from the corresponding aldehyde by heating the aldehyde in a methanol solvent using a catalytic amount of protic acid, e.g., p-toluenesulfonic acid. Use of a dehydrating agent or other means of water removal will drive the equilibrium of the reaction towards the dimethyl acetal product. Other acetals can be prepared in the same way using a different alcoholic solvent, e.g., ethanol may be used as a solvent for preparing the diethyl acetal.

### Example 6: Calibration of Gas Chromatograph for Odor Detection

Odor detection thresholds may be determined using a gas chromatograph. The gas chromatograph is calibrated to allow determination of the exact volume of material injected by the syringe, the precise split ratio, and the hydrocarbon response using a hydrocarbon standard of known concentration and chain-length distribution. The air flow rate is measured and the sampled volume is calculated based on the assumed duration of a human inhalation of 12 seconds. Since the precise concentration at the detector at any point in time may be determined as described above, the mass per volume inhaled can be calculated, and hence, the concentration of material tested. To determine whether a material has a detectable odor threshold below 50 ppb, solutions are delivered to the sniff port at a concentration calculated using the method described above. Subsequently, a panelist sniffs the effluent from the gas chromatograph and identifies the retention time at which odor is noticed. Averaged data from all panelists yields the threshold of noticeability.

A calculated amount of analyte is injected onto the gas chromatograph column to achieve a 50 ppb concentration at the detector. Typical gas chromatograph parameters for determining odor detection thresholds via the method are listed below.
GC: 5890 Series II with FID detector
7673 Autosampler
Column: J&W Scientific DB-1
Length 30 meters ID 0.25 mm film thickness 1 micron
Method:
Split Injection: 17/1 split ratio
Autosampler: 1.13 microliters per injection
Column Flow: 1.10 mL/minute
Air Flow: 345 mL/minute
Inlet Temp. 245° C.
Detector Temp. 285° C.
Temperature Information
Initial Temperature: 50° C.
Rate: 5 C/minute
Final Temperature: 280° C.
Final Time: 6 minutes
Leading assumptions:
   (i) 12 seconds per sniff
   (ii) GC air adds to sample dilution

### Example 7: Olfactory Analysis of 9-hydroxy-9-methyldecanal

Aqueous 9-hydroxy-9-methyldecanal prepared by the method of Example 2 was sampled on a fragrance blotter to assess the compound's aroma.

9-hydroxy-9-methyldecanal was first presented on a blotter neat. It was found to have a muguet-type aroma, similar to “lily of the valley,” with a pleasant, soft, and sweet floral character. also has a strong tenacity.

A 10% dilution in triethylcitrate of 9-hydroxy-9-methyldecanal synthesized by the method of Example 2 was then prepared and sampled on a blotter. The 10% dilution produced a similar and positive aroma. The tenacity on the blotter was on the order of 5-10 hrs.

The olfactory analysis of 9-hydroxy-9-methyldecanal demonstrated that the compound can be used to impart a desirable aroma to fragrance compositions.

Having now described some embodiments of the application, it should be apparent to those skilled in the art that the foregoing is merely illustrative and not limiting, having been presented by way of example only. The embodiments of the application can therefore be in other specific forms without departing from the spirit or essential characteristics thereof.

Those skilled in the art should recognize or be able to ascertain, using no more than routine experimentation, equivalents to the specific embodiments of the application. It is therefore to be understood that the embodiments described herein are presented by way of example only and that the scope of the application is thus indicated by the appended claims and equivalents thereto, and that the application may be practiced otherwise than as specifically described in the foregoing description.

### INCORPORATION BY REFERENCE

The entire disclosure of each of the patent documents and scientific articles referred to herein is incorporated by reference for all purposes.

### EQUIVALENTS

The application can be embodied in other specific forms without departing from the spirit or essential characteristics thereof. The foregoing embodiments are therefore to be considered in all respects illustrative rather than limiting on the application described herein. Scope of the application is thus indicated by the appended claims rather than by the foregoing description, and all changes that come within the meaning and range of equivalency of the claims are intended to be embraced therein.

1. A fragrance composition comprising a compound of Formula I 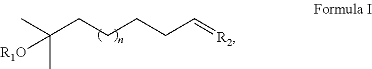
Formula II, 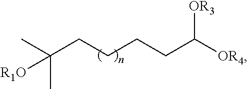
or
Formula III 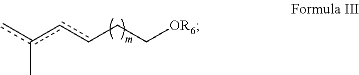
wherein:
R₁ is H, C₁₋₆ alkyl, or —C(O)C₁₋₆ alkyl;
R₂ is O, CH₂, or CHC₁₋₆ alkyl;
R₃ and R₄ are each C₁₋₆ alkyl; and
R₆ is H, C₁₋₆ alkyl, or —C(O)C₁₋₆ alkyl;
n is an integer from 0 to 6; and
m is and integer from 1 to 6;
wherein at least one of the [symbol] is a double bond, and the remaining [symbol] are single bonds, provided that two adjacent [symbol] are not both double bonds.

2. The fragrance composition of claim 1, comprising a compound of Formula I.

3. The fragrance composition of claim 1, wherein R₁ is H, CH₃, or CH₂CH₃.

4. The fragrance composition of claim 1, wherein R₁ is —C(O)CH₃.

5. The fragrance composition of claim 1, wherein R₂ is CH₂ or CHCH₃.

6. The fragrance composition of claim 1, wherein R₂ is O.

7. The fragrance composition of claim 1, wherein the compound of Formula I or the compound of Formula II or the compound of Formula III imparts a fragrance to the fragrance composition.

8. The composition of claim 1, comprising a compound of Formula II.

9. The composition of claim 8, wherein R₃ and R₄ are methyl.

10. The composition of claim 8, wherein n is 4.

11. (canceled)

12. The composition of claim 1, comprising a compound of Formula III.

13. (canceled)

14. (canceled)

15. A fragrance composition comprising a compound selected from the group consisting of: 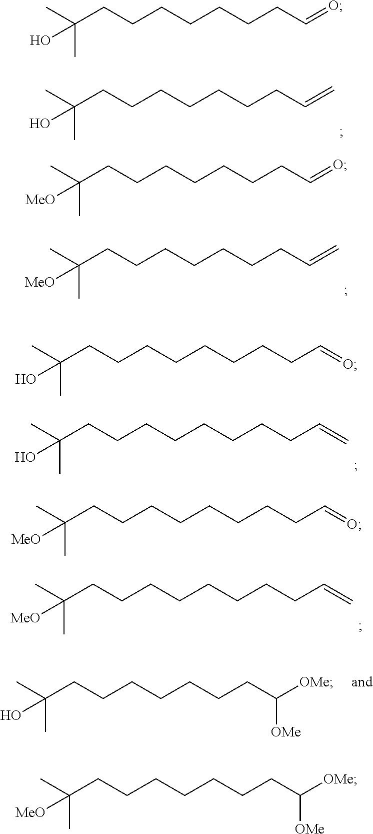
wherein the compound imparts a fragrance to the fragrance composition.

16. A fragrance composition comprising 9-hydroxy-9-methyldecanal: 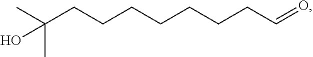
wherein the 9-hydroxy-9-methyldecanal imparts a fragrance to the fragrance composition.

17. The fragrance composition according to claim 1, wherein the concentration of the compound of Formula I, Formula II, or Formula III is 0.0005% to 99.9% by mass, 0.0005% to 10% by mass, 0.0005% to 1% by mass, 0.05% to 50% by mass, 0.05% to 10% by mass, 0.05% to 1% by mass, 0.5% to 10% by mass, or 0.5% to 5% by mass.

18. (canceled)

19. (canceled)

20. (canceled)

21. (canceled)

22. (canceled)

23. The fragrance composition of claim 1, further comprising one or more additives, one or more fragrance ingredients, or a combination thereof.

24. The fragrance composition of claim 1, wherein the fragrance composition further comprises at least one additive.

25. The fragrance composition of claim 24, wherein the additive comprises a surfactant.

26. The fragrance composition of claim 1, wherein the composition further comprises at least one fragrance ingredient.

27. The fragrance composition of claim 26, wherein the fragrance ingredient comprises an oil.

28. The fragrance composition of claim 1, wherein the fragrance composition further comprises at least one additive and at least one fragrance ingredient.

29. A product comprising the fragrance composition according to claim 1, wherein the product is a perfume, air freshener, laundry detergent, household cleaning product, liquid or bar soap, shampoo, conditioner, hair spray, cosmetic, deodorant, insect repellant, insecticide, or pet litter.

30. (canceled)

31. (canceled)

32. (canceled)

33. (canceled)

34. (canceled)
